(19) United States
(12) Patent Application Publication
(10) Pub. No.: US 2014/0109386 A1
(43) Pub. Date: Apr. 24, 2014

(54) Non ionic/electrolyte, liquid/gaseous, mechanically refined/nanoparticle dispersion Building Materials/High Wear-Heat Resistant Part Brushes, Windings, Battery Cells, Brake Pads, Die Cast Molding, Refrigeration, Polarized/Integrated Optical, Spectrometric Processors, Central Processor Unit Processors, Electronic Storage Media, Analogous Series/Parallel Circuit Generators/Transceivers, Particulate Matter PM Carbonaceous-Polyamide, Crystalline Silica, and Cellulosic Filament Extraction/Miners Suit

(71) Applicant: Robert Richard Matthews, Washington, DC (US)

(72) Inventor: Robert Richard Matthews, Washington, DC (US)

(21) Appl. No.: 13/689,789

(22) Filed: Nov. 30, 2012

Related U.S. Application Data
(63) Continuation-in-part of application No. 13/656,682, filed on Oct. 20, 2012.

(51) Int. Cl. B23P 13/00

(52) U.S. Cl. CPC B23P 13/00
USPC 29/592

(57) ABSTRACT

The variable hydraulic press and distillation reservoir manufacture process scientific formula non ionic or electrolyte mechanically refined and nanoparticle, allotropes of carbon dispersion preform slurry extrusion, with or without ionic suspension element for manufactured Preform slurry high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, electronic resistors, transformers, transducers, rectifiers, power supplies, or heat sinks Preform slurry high wear-heat resistant parts aerospace, automotive, and transportation brake calipers, rotors, pads, and bushings Preform slurry non ionic or electrolyte mechanically refined and nanoparticle high wear-heat resistant parts precision casting molds 2.5 phase die cast molding and Building Materials fine concrete, mortar, brick, and tiles.

### DOMESTIC PRIORITY DATA

This is an application a continuation in part of preliminary amendment to specification application Ser. No. 13/656,682 Filing Date Oct. 20, 2012.

### BACKGROUND OF THE INVENTION

Global warming and growing concerns of Greenhouse gas emissions from our dependency on fossil fuels are creating real demand and awareness for an electric alternative to fossil fuel engines and expensive replacement parts. Few technological developments of collecting and manufacturing allotropes of carbon improve upon our existing technological structure. By applying scientific utilization of preform technology variable hydraulic preform slurry non ionic or electrolyte mechanically refined and nanoparticle dispersion high wear-heat resistant parts press with manufactured or processed allotropes of carbon assembled resources we can now create the manufacture process of preform slurry non ionic or electrolyte mechanically refined and nanoparticle high wear-heat resistant parts.

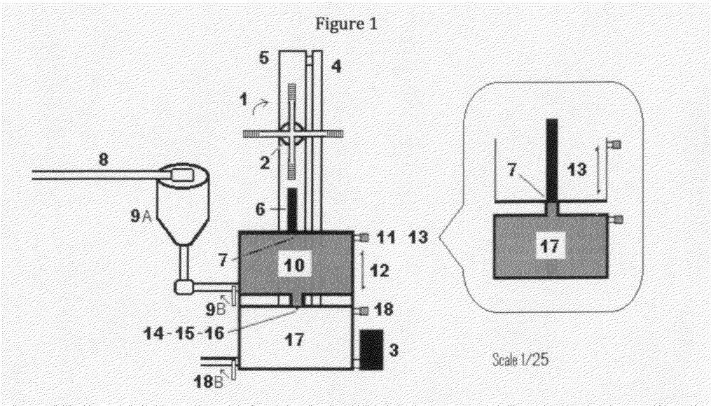

### BRIEF DESCRIPTION OF FIG. 1

FIG. 1 variable hydraulic preform slurry non ionic or electrolyte mechanically refined and nanoparticle dispersion high wear-heat resistant parts press.

### DETAILED DESCRIPTION OF FIG. 1

Variable hydraulic preform slurry non ionic or electrolyte mechanically refined and nanoparticle dispersion high wear-heat resistant parts press 1—Hydraulic control wheel 2—Electronic servo processor 3—Hydraulic pump 4—Hydraulic pipe 5—Hydraulic actuator 6—Hydraulic tool steel arm 7—Slurry non ionic and electrolyte tool steel press plate 8—Slurry non ionic and electrolyte tool steel line in 9A—Gravity feed tool steel collector 9B—Tool steel release portal control 10—Slurry non ionic and electrolyte tool steel reservoir 11—Slurry non ionic and electrolyte reservoir regulated tool steel carbonaceous-polyamide waste filtration 12—Slurry non ionic and electrolyte tool steel reservoir expanded 13—Slurry non ionic and electrolyte tool steel reservoir contracted 14—Slurry non ionic and electrolyte reservoir brass-tool steel aperture 15—Tool steel extrusion die cast design brass-tool steel fitting 16—Tool steel electronic servo processor or manual stop control release pull pin 17—Tool steel extrusion die cast design internal cavity 18—Tool steel extrusion die cast design internal cavity regulator carbonaceous-polyamide waste filtration and 18B—Tool steel vacuum release portal control.

### BRIEF SUMMARY OF THE INVENTION

Scientific utilization of preform technology variable hydraulic preform slurry non ionic or electrolyte mechanically refined and nanoparticle dispersion high wear-heat resistant parts press FIG. 1 with manufactured or processed allotropes of carbon available resources enables the manufacture process of high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts, aerospace, automotive, transportation brake calipers, rotors, pads, washers, spacers, shims, dowels, bushings, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, and precision casting molds for the manufacturing of highly pure metal, super alloy, highly pure naturally occurring carbon, ceramics, silica alumina or molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, acid solids, alkaline, glass, acrylic, synthetic polymers, halide, alkalide, antimonide, nonconductive zirconia, allotropes of carbon, alternate carbon nanofoam inductor ACNFI, and impedance matching load or signal ceramic red brick clay insulators 1.0 to 2.5 phase extrusions for each A and B specification part.

### DETAILED DESCRIPTION OF THE INVENTION

The variable hydraulic preform slurry non ionic or electrolyte mechanically refined and nanoparticle dispersion allotropes of carbon atomic number 6 symbol C herein referred to as preform slurry non ionic or electrolyte mechanically refined and nanoparticle high wear-heat resistant parts press the center of this utility patent application specification manufacture process of specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 55 elements and/or Specification 56 alloys manufactured 1. preform slurry non ionic or electrolyte mechanically refined and nanoparticle high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 2. preform slurry non ionic or electrolyte mechanically refined and nanoparticle high wear-heat resistant parts aerospace, automotive, and transportation brake calipers, rotors, pads, washers, spacers, shims, dowels, and bushings 3. preform slurry non ionic or electrolyte mechanically refined and nanoparticle high wear-heat resistant parts precision casting molds for the manufacturing of highly pure metal, super alloy, highly pure naturally occurring carbon, ceramics, silica alumina or molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, acid solids, alkaline, glass, acrylic, synthetic polymers, halide, alkalide, antimonide, nonconductive zirconia, allotropes of carbon, alternate carbon nanofoam inductor ACNFI, and impedance matching load or signal ceramic red brick clay insulators 1.0 to 2.5 phase extrusions for each A and B specification part and 4. Building Materials preform slurry specification formula non ionic or electrolyte acid, base, or alkyl distillation reservoir specification vacuum processing scientific electrolysis covalent bonding sequence drawing and spinning formula solutions mechanically refined and nanoparticle dispersion fine concrete, mortar, brick, and tiles.

A cool complete vacuum draws any one particulate matter while fluxing gaseous suspension creates the partial vacuum causing atmospheric suspension particulate matter diffusion equal particle distribution or saturation.

A prepared heated specification particulate matter partial vacuum fluxing suspension distillation reservoir continually extracting expanded higher temperature particulate matter melts the instantaneous creation of particulate matter parts of any two or more particulate matter materials resultant compound particulate matters.

The specification making of particulate matter extremely high optical grade silicon filtered and non filtered, high optical grade allotropes of carbonaceous-silicon particulate matter, high optical grade allotropes of carbonaceous-silicon particulate matter polyamides synthetic resins, high optical grade silicon filtered and non filtered polyamides synthetic resins, potassium ash and feldspar K 19, gypsum CaSO4.2H2O 20, zirconium Zr 40, S 16 quartz-bearing basalt Ca 20, cobalt Co 27, silica dioxide SiCO₂, sodium oxide Na₂O, calcium oxide CaO, polyethylene, synthetic polymer resins, hybrid allotropes of carbon, molecular silica hybrid allotropes of carbon molecular dioxide SiCO₂, molecular sodium oxide Na₂O compound, molecular calcium oxide CaO, alkalines with or without magnesium Mg powdered resins, alternate carbon nanofoam inductor ACNFI, molecular and nanoparticle alumina Al13, fluoride F, Specification 55 elements, natural cellulosic polyamides resins, natural cellulosic polyamide rubber resins, natural carbonaceous resins, allotropes of carbonaceous nanoparticles, and natural cellulosic fiberaceous resins, allotropes of carbonaceous-silicon particulate matter cement clinkers and sands, high tensile strength heat resistant allotropes of carbonaceous-metals, allotropes of carbonaceous-polyamides synthetic resins, extremely hard heat resistant heavy mineral cement clinkers and sands, fine minerals and sands, ceramic red brick clay impedance matching load or signal insulators, and complex alkaline and acid powders.

The specification making of supersaturated particulate matter under and above normal atmospheric pressure measured in atmospheres and bars of pressure two or more particulate matter materials supercooled 0° C. or 32° F. interface tool steel, and specification acid, bases, and alkyls gaseous partial and complete suspensions of preform slurry non ionic or electrolyte forming as a naturally occurring phenomenon named cloud condensation nuclei or CCNs also known as cloud seeds are small particles typically 0.2 μm, or 1/100th the size of the

average cloud droplet. The liquid vapor requires a non-gaseous surface to make the transition from a vapour to a liquid. The supercooled liquids of condensation nuclei particulate matter one and two or more condensation nuclei particulate matter materials resultant condensation nuclei particulate matters maybe electrolysis spun, drawn, evaporated, dispersed, casted, extruded and formed into resin powders. The liquids of condensation nuclei particulate matter materials maybe continuously solution processed into silicon gels with or without potassium ash and feldspar K 19, gypsum CaSO4.2H2O 20, zirconium Zr 40, S 16 quartz-bearing basalt Ca 20, cobalt Co 27, silica dioxide SiCO₂, sodium oxide Na₂O, calcium oxide CaO, carbon dioxide CO₂, synthetic polymer resins, hybrid allotropes of carbon and molecular dioxide CO₂ compound, molecular silica hybrid allotropes of carbon molecular dioxide SiCO₂ compound, molecular sodium oxide Na₂O compound, and molecular calcium oxide CaO, alkalines with or without magnesium Mg powdered resins, alternate carbon nanofoam inductor ACNFI, molecular and nanoparticle alumina Al13, fluoride F, Specification 55 elements, natural cellulosic polyamides resins, natural cellulosic polyamide rubber resins, natural carbonaceous resins, allotropes of carbonaceous nanoparticles, and natural cellulosic fiberaceous resins drawn annealing print rolled films sheets, cut strips, spun wire line, spinning yarn and thread insulates.

Distillation reservoir and recovery basin made of super alloy, and/or ceramic, and/or allotropes of carbon or alternate carbon nanofoam inductor ACNFI filler and adhesive insulator including variable hydraulic press plate for specification distillation processing. Polarized windshields, optical glass, polymers gels distillation positively and negatively charging electrolysis of molten glass, optical glass, reflective beads, polymer gels, lenses, mirrors, polarized windshield casted or molten diffusion forged, and molten specification materials 1.0 to 2.0 phase casted or extruded and distillation processing of specification highly pure metal, super alloy, ceramic, and alkaline. Windshield and specification materials are chemically surface treated distillation processed with specification acid and bases and Specification 55 elements or mechanically refined and nanoparticle specification acid and bases dispersions. Electrolysis electroplating of mechanically refined and nanoparticle Specification 55 elements, Specification 56 alloys, nanoparticle alumina, allotropes of carbon, alternate carbon nanofoam inductor ACNFI series and parallel circuits. Electrolysis distillation positively and negatively charged electron molecules allotropes of carbon, alternate carbon nanofoam inductor ACNFI, nanoparticle alumina, Specification 55 elements, and Specification 56 alloys with greater and lesser than normal atmospheric pressure, super heating, super cooling scientific molecular diffusion, and fractional distillation are accomplished. Distillation processing mechanically refined particles measure in microns Symbol μ lower-case letter mu metric SI equivalent silica mineral, mineral sands, heavy minerals, alumina, nanoparticle alumina, highly pure naturally occurring carbon, alkaline, acid solids, allotropes of carbon, alternate carbon nanofoam inductor ACNFI, gold, silver, platinum, lead, acrylic and synthetic polymers catalyst gaseous and electrolysis process material for sintering and smelting pouring molten materials to apertures of variable hydraulic press plate, die cast extrusion molds, crucibles, and mold casings. Other distillation processing mechanically refined and nanoparticle preform slurry non ionic or electrolyte dispersion or molten highly pure metal, super alloy, highly pure naturally occurring carbon, allotropes of carbon, alternate carbon nanofoam inductor ACNFI, nanoparticle alumina, alumina, silica alumina or molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, silica mineral, mineral sands, heavy minerals, glass, acrylic, synthetic polymer, acid solid, impedance matching ceramic red brick insulator, molybdenum, ceramic zirconia, ceramic silica, ceramic clay, calcium carbonate CaCO₃, silicon dioxide SiO₂, sodium oxide Na₂O, calcium oxide CaO, alkaline, minerals, including ionic suspension elements and ceramic silica mineral insulator for Specification 55 elements highly pure metal, and Specification 56 alloys. Distillation reservoir specification manufactured battery conservation of energy cool and cold low temperature operating range made Series of right angles 2π radians or one full turn the sum of the exterior angles form convex regular polygons corrugated and compartmented architecture techniques monocombe shapes of triangle square pentagon hexagon heptagon octagon and nonagon and right angle combinations light makeweight design electromagnetic conductive Liquid and gaseous suspension elements of group 17 the halogens, highly pure ammonia Nh3, antimony Sb, methane Ch4, hydrogen allotropes of carbon HC hydrocarbons compound and Specification 55 elements electromagnetic conductive Liquid and gaseous suspension mechanically refined particles measure in microns Symbol μ lower-case letter mu metric SI equivalent alumina particles, alkaline particles, nickel particles, cadmium particles, lithium particles, magnesium particles, lead particles, fused ionic material complex mechanically refined particles measure in microns Symbol μ lower-case letter mu metric SI equivalent acid complex particles, alkaline complex particles, antimonide complex particles, halide complex particles, alkalide complex particles, mechanically refined particles measure in microns Symbol μ lower-case letter mu metric SI equivalent Specification 55 conductive elements and Specification 56 conductive alloys, allotropes of carbon, alternate carbon nanofoam inductor ACNFI, and nanoparticle alumina measure in nanometers Nm. Distillation processing and/or for up to four molten pours 1.0 to 1.0 to 2.5 phase casted or extruded or preform slurry non ionic or electrolyte. Molten pours and variable hydraulic press plate preform slurry non ionic or electrolyte mechanically refined and nanoparticle dispersion under vacuum control room scientific distillation ordinary atmospheric pressure less than ordinary atmospheric pressure catalyst gases other Specification 55 elements argon, carbon monoxide, carbon dioxide, or other gases mechanically refined or nanoparticle suspension catalyst greater or lesser than ordinary atmospheric pressure molecular diffusion, super cooling, and fractional distillation specification suspension may also accomplish allotropes of carbon hybridizations. Super alloy super cooling refrigeration vacuum pump and super alloy curved or linear expression comprising a scientific aperture, a divergence measured in angulation, and a scientific aperture diffusive gaseous particle vacuum pump negative pressurized stream accelerator super cooling refrigeration deceleration with or without nanoparticle synthesizing laser ablation and multi-waveform ablation X, Y, Z alignment with or without fluxing agents, nanoparticle alumina al13, and fractional vacuum distillation gaseous and/or positive and negative ionic charges recovery and super alloy and/or ceramics and/or highly pure naturally occurring carbon and allotropes of carbon filler and adhesive insulator distillation reservoir variable hydraulic press plate expanded and contracted greater or lesser than ordinary atmospheric pressure distillation recovery fractional vacuum distillation gaseous and/or positive distillation and variable hydraulic press plate expanded and contracted greater or lesser than ordinary atmospheric pressure distillation recovery allotropes of 6C carbon, carbon, solid, liquid, and gases chemical non ionic groups of amphoteric polysaccharide linear or branched alkyl compounds or electrolytes and/or liquid ions and/or ionic melts and/or fused and/or acid and bases catalyst and/or catalyst slurry reservoir 6C allotropes of carbon and liquid and/or liquid vapors and/or gaseous electrolyte catalyst acids and solid materials highly pure metal, super alloy, highly pure naturally occurring carbon, allotropes of carbon, alternate carbon nanofoam inductor ACNFI, nanoparticle alumina, alumina, silica alumina or molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, silica mineral, mineral sands, heavy minerals, glass, acrylic, synthetic polymer, acid solid, impedance matching ceramic red brick insulator, molybdenum, ceramic zirconia, ceramic silica, ceramic clay, calcium carbonate CaCO₃, silicon dioxide SiO₂, sodium oxide Na₂O, calcium oxide CaO, alkaline, minerals, including ionic suspension elements and ceramic silica mineral insulator for Specification 55 elements highly pure metal, and Specification 56 alloys for building materials preform slurry specification formula non ionic or electrolyte acid, base, or alkyl distillation reservoir specification vacuum processing scientific electrolysis covalent bonding sequence drawing and spinning formula solutions mechanically refined and nanoparticle dispersion fine concrete, mortar, brick, and tiles, and high wear-heat resistant parts brushes, windings, coils, battery cells, electronic resistors, capacitors, brake pads, washers, spacers, bushings, annealing, drawn, spun, coils, windings, wire, woven textile mesh, shielding, and 1.0 to 2.5 phase casted or extruded die cast molding. An insulate, electronic part, brake calipers part, rotors part, brake pads, washers, spacers, shims, dowels, bushings part light weight chemical ionic acid usually an amino acid, non ionic bases usually nitrogen/hydrogen or non ionic groups of amphoteric polysaccharide linear or branched alkyl compounds usually methyl continuous sheets cut films insulate, specification formula non ionic or electrolyte acid, base, or alkyl distillation reservoir specification vacuum processing scientific electrolysis covalent bonding sequence drawing and spinning formula solutions mechanically refined and nanoparticle dispersion continuous spinning yarn and thread, preform optical grade silica, forged optical grade silica line cable, preform optical grade natural polymer or synthetic polymer silica, forged optical grade polyamide silica line cable, variable hydraulic press, plate or distillation reservoir liquid dispersion and particulate matter PM specifications of nanoparticle and condensation-nuclei type size particles measure in microns Symbol μ lower-case letter mu metric SI equivalent natural polymer carbon, natural polymer or synthetic polymer carbon, allotropes of carbon, silica, allotropes of carbon silica and alumina/nano alumina silica allotropes of carbon slurry non ionic heated or chilled interface 8—Slurry non ionic tool steel line in heated or chilled chemical ionic acid usually an amino acid, non ionic bases usually nitrogen/hydrogen or non ionic groups of amphoteric polysaccharide linear or branched alkyl compounds usually methyl liquid dispersion liquid dispersion heated chemical non ionic groups of amphoteric polysaccharide linear or branched alkyl compounds methyl liquid dispersion natural polymer carbon, natural polymer or synthetic polymer carbon, allotropes of carbon, allotropes of carbon silica, allotropes of carbon silica alumina/nano alumina and allotropes of carbon alumina/nano alumina or liquid dispersion chilled polysaccharide linear or branched alkyl compounds and reinforcement of allotropes of carbon networks in suspension drying over usually fifteen minutes result network light weight natural polymer carbon, natural polymer or synthetic polymer carbon, allotropes of carbon, allotropes of carbon silica, allotropes of carbon silica alumina/nano alumina and allotropes of carbon alumina/nano alumina controllable, high purity, connectivity, strength, conductivity, and/or shape.

Building Materials preform slurry specification formula non ionic or electrolyte acid, base, or alkyl distillation reservoir specification vacuum processing scientific electrolysis covalent bonding sequence drawing and spinning formula solutions mechanically refined and nanoparticle dispersion fine concrete, mortar, brick, and tiles. Building materials preform modular fine concrete arrives in trucks readymade utilized with manufacture process connector system die cast super alloy or tool steel molten-forged crimping tool heated or cooled particulate matter carbonaceous-polyamide interwoven textile mesh, and molten-forged super alloy or tool steel connectors that work with easy to build box framing techniques, hydraulic cement on-site preform modular casting molds and preform modular fine readymade concrete poured directly from hydraulic and vacuum pumps on readymade truck. Preform modular manufacture process connector system surveying tools and techniques ionic paint markers and alidade Very high frequency VHF and Ultra high frequency UHF industrial/business narrowband 12.5 kHz bandwidth efficiency technology utilizing crystal quartz transceiver transmitting and receiving to crystal quartz transceiver ground mode-C marker Earth Positioning System EPS transmitting and receiving mode-C for construction generator wavenumber data added and subtracted order identification in nanoseconds processing geodetic spatial datum reference Universal Transverse Mercator UTM geographic six-ten digit grid coordinates, distance, azimuth, and level reference identification Cartesian system datum numeric generation returns coordinates in a local east-north-up ENU Cartesian system corresponding to coordinates X, Y, Z in an Earth-Centered Earth-Fixed ECEF spheroid-centric Cartesian system. Ready mix mortar is packaged and distributed in specially made thermoplastic sealed injection molded preformed containers and airtight dispenser system. Specialized construction abatement and miners suit carbonaceous-polyamide textile interwoven mesh push to talk PTT and self-actuating microphone intercommunication system, textile woven rip-stop technique sewn fibers, liners, air tight light makeweight head gear, crystalline silica optical and crystalline silica optical natural polymer carbon, natural polymer or synthetic polymer carbon filtered and non filtered visor, inner layer air pressurized isolated breathable oxygen gaseous mixture supplied by light makeweight textile woven carbonaceous-polyamide, carbonaceous fiberaceous, and composite materials, knitted/stitched textile fabrics, and woven-mesh in X, Y, and Z alignment rip-stop reinforcing technique weaving thick reinforcement threads interwoven at regular intervals in a crosshatch pattern fabrics having thin and light makeweight structure from thick threads being interwoven in a thinner cloth sewn fibers oxygen tank and second dormant layer carbon dioxide CO₂ accelerated supercooled system powered by magnesium nanoparticle light makeweight battery cell.

Supplemental super alloy super cooling refrigeration vacuum pump and super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant super cooling super alloy or super alloy. Refrigerant specification of naturally occurring carbon dioxide CO₂ and distillation reservoir specification hybridizations of allotropes of carbon, solution pure oxides O₂, distillation reservoir covalent bonding, electrolysis, and molecular diffusion produce hybrid allotropes of carbon and molecular dioxide CO₂ compound, silica hybrid allotropes of carbon molecular dioxide SiCO₂ compound, chloride hybrid allotropes of carbon CCl compound, methane Ch4, nitrate hybrid allotropes of carbon NC compound, and hydrogen hybrid allotropes of carbon HC compound. High negative pressurized levels are maintained by vacuum pump circuit.

Self contained naturally occurring carbon dioxide CO₂, hybrid allotropes of carbon and molecular dioxide CO₂ compound, methane Ch4, nitrate hybrid allotropes of carbon NC compound, and hydrogen hybrid allotropes of carbon HC compound refrigeration units commercial, residential, or portable super alloy vacuum pump drawing gaseous refrigerant through insulated super alloy feeder tubes in a parallel circuit to separate super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant is then passed over super alloy and through cooling fan. High negative pressurized levels are maintained by vacuum pump circuit.

Self contained naturally occurring carbon dioxide CO₂, hybrid allotropes of carbon and molecular dioxide CO₂ compound, methane Ch4, nitrate hybrid allotropes of carbon NC compound, and hydrogen hybrid allotropes of carbon HC compound refrigeration units commercial, residential, or portable super alloy vacuum pump rated alternating current AC or direct current DC drawing gaseous refrigerant through insulated super alloy feeder tubes in a parallel circuit to separate numeric super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant passes over super alloy and through cooling fan. Numeric isolated super alloy cylinders in series and parallel thermo conductive circuits are connected to the refrigeration unit from super alloy connecting rods super cooling the outside walls of the cylinders. The outer cylinder cools activating an electronic air compressor rated alternating current AC or direct current DC filling the inner variable cylinders with compressed air providing diffusive compensation expanding the inner cylinders forcing the carbon dioxide CO₂ filled outer cylinders through a continuous circuit of super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to greater than −109 degrees Fahrenheit or −78.5 degrees Celsius carbon dioxide CO₂ forming dry ice in the outer internal cylinders. High negative pressurized levels are maintained by vacuum pump circuit.

Distillation and recovery basin automation mass production variable hydraulic press plate mold and Super alloy, and/or ceramic, and allotropes of carbon, and alternate carbon nanofoam inductor ACNFI filler and adhesive insulator pour aperture located in the center and hydraulic cylinder located on the right expanded and contracted for molten pouring highly pure metal printed circuits, super alloy including allotropes of carbon printed circuits nickel, cadmium, lithium, lead, antimonide, halide, alkalide, Specification 55 elements printed circuits, or Specification 56 alloys printed circuits and/or ceramic insulator for 1.0, and 2.0 phase extrusion plates, sheets, foil, and leaf central processing unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silic allotropes of carbon insulator. Distillation and recovery basin automation mass production crucible casted molten highly pure metal printed circuits, super alloy, allotropes of carbon printed circuits nickel, cadmium, lithium, lead, antimonide, halide, alkalide, Specification 55 elements printed circuits, or Specification 56 alloys printed circuits and/or ceramic insulator for 1.0, and 2.0 phase castings plates, sheets, foil, and leaf central processing Unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica allotropes of carbon insulator. Distillation and recovery basin automation mass production variable hydraulic press plate mold and Super alloy, and/or ceramic, and allotropes of carbon, and alternate carbon nanofoam inductor ACNFI filler and adhesive insulator pour aperture located in the center and hydraulic cylinder located on the right expanded and contracted for pouring non ionic or electrolyte preform slurry with mechanically refined and nanoparticle dispersion fine printing highly pure metal printed circuits, allotropes of carbon, alumina nanoparticles, copper nanoparticles, colloidal gold, silver nanoparticles, iron nanoparticles, element nanoparticles and platinum nanoparticles printed circuits, super alloy including allotropes of carbon printed circuits, allotropes of carbon printed circuits, alternate carbon nanofoam inductor ACNFI printed circuits, allotropes of carbon ionic suspension element printed circuits nickel, cadmium, lithium, magnesium, lead, antimonide, Specification 55 elements printed circuits, or Specification 56 alloys printed circuits and/or ceramic insulator for 1.0, and 2.0 phase extrusion plates, sheets, foil, and leaf central processing unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica allotropes of carbon insulator. Distillation and recovery basin automation mass production crucible casted non ionic or electrolyte preform slurry with mechanically refined or nanoparticle dispersion fine printing highly pure metal printed circuits, allotropes of carbon, alumina nanoparticles, copper nanoparticles, colloidal gold, silver nanoparticles, iron nanoparticles, element nanoparticles and platinum nanoparticles printed circuits, super alloy including allotropes of carbon printed circuits, allotropes of carbon printed circuits, alternate carbon nanofoam inductor ACNFI printed circuits, allotropes of carbon ionic suspension element printed circuits nickel, cadmium, lithium, magnesium, lead, antimonide, Specification 55 elements printed circuits, or Specification 56 Alloys printed circuits and/or ceramic for 1.0, and 2.0 phase castings plates, sheets, foil, and leaf central processing Unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica allotropes of carbon insulator. Distillation reservoir interchangeable combinations of preform slurry non ionic, electrolyte, or molten ceramic and conductive circuits 2.0 extrusions or castings are accomplished for each specification part. Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 55 Elements spectrum.

Alternate carbon nanofoam inductor ACNFI electronic storage media is manufactured plates, sheets, foil, or leaf on ceramic, highly pure metal, super alloy, or distillation reservoir alternate carbon nanofoam inductor ACNFI annealing, drawing, and spun pressed electronic tape 3250 bits per second BPS, 6250 bits per second BPS, 7 MM millimeter, and compact disc CD writable random access memory WRAM.

Manufacture process of 1.0 to 2.5 phase extrusions die cast molding for precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated and casted or molten diffusion forged polarized reflective beads radiate outwards up to and greater than 400 percent magnification for aircraft and airway systems, and allotropes of carbon, or alternate carbon nanofoam inductor ACNFI filler and adhesive insulator.

The precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated and casted or molten diffusion forged polarized reflective beads radiate outwards up to and greater than 400 percent magnification for aircraft and airway systems, and allotropes of carbon, or alternate carbon nanofoam inductor ACNFI filler and adhesive insulator is a layered greater than 0% to less than 100% precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated, polarized casted and molten diffusion forged reflective beads radiate outwards up to and greater than 400 percent magnification for aircraft and airway systems, and allotropes of carbon, or alternate carbon nanofoam inductor ACNFI filler and adhesive insulator and greater than 0% to less than 100% other precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated, polarized casted and molten diffusion forged reflective beads radiate outwards up to and greater than 400 percent magnification for aircraft and airway systems, and allotropes of carbon, or alternate carbon nanofoam inductor ACNFI filler and adhesive insulator part that is created by pouring molten metal, alloy, halide, alkalide, antimonide, ceramic, glass, acid solid, alkaline, synthetic polymer, non molten formula ceramic slip, acid solid, alkaline, and preform slurry non ionic or electrolyte allotropes of carbon, or alternate carbon nanofoam inductor ACNFI filler and adhesive insulator into a cast mold over a process of 1.0 to 2.5 phase extrusions that create two to six molded casts for each designed master tool steel part that is manually machined and manufactured named part X external layer highly pure metal, super alloy, halide, alkalide, antimonide, ceramic, glass, acid solid, alkaline, synthetic polymer, including preform slurry non ionic or electrolyte allotropes of carbon, or alternate carbon nanofoam inductor ACNFI filler and adhesive insulator and Part Z the internal layer other highly pure metal, super alloy, halide, alkalide, antimonide, ceramic, glass, synthetic polymer, acid solid, alkaline, including preform slurry non ionic or electrolyte allotropes of carbon, or alternate carbon nanofoam inductor ACNFI filler and adhesive insulator. Manufactured process of 1.0 to 2.5 phase extrusions die cast molding for precision casting of super alloy, ceramic, and material ultimately create a single part identical to the master designed and machine manufactured part with the exception to the chemical element is now a super alloy, super alloy ceramic, or super material that may be layered greater than 0% to less than 100% highly pure metal, super alloy, super material, including allotropes of carbon, or alternate carbon nanofoam inductor ACNFI filler and adhesive insulator and greater than 0% to less than 100% other highly pure metal, super alloy, super material including allotropes of carbon, and alternate carbon nanofoam inductor ACNFI filler and adhesive insulator. Processing molded halves sequence 1 to 9 of manufacture process 1.0 to 2.5 phase extrusions die cast molding for precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated, polarized casted and molten diffusion forged reflective beads radiate outwards up to and greater than 400 percent magnification for aircraft and airway systems, and allotropes of carbon, or alternate carbon nanofoam inductor ACNFI filler and adhesive insulator part X and part Z side profile not shown here of casting for part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 filled with molten on non molten formula materials including preform slurry non ionic or electrolyte allotropes of carbon, or alternate carbon nanofoam inductor ACNFI filler and adhesive insulator sequence 9. The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace.

The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry. The external tolerances of all of the four cast covers X and Z are identical opposing so that X and Z halves can be joined and prepared for two separate halves molten or non molten formula highly pure metal, super alloy, or material including allotropes of carbon, or alternate carbon nanofoam inductor ACNFI filler and adhesive insulator fills. After the poured molten highly pure metal, super alloy, or materials including allotropes of carbon, or alternate carbon nanofoam inductor ACNFI filler and adhesive insulator cools or cures then both extruded halves are removed and stored. The remainder halves with highly pure metal, super alloy, or materials including allotropes of carbon, or alternate carbon nanofoam inductor ACNFI filler and adhesive insulator are then joined and prepared for a second molten fill of greater than 0% to less than 100% highly pure metal, super alloy, or materials including allotropes of carbon, or alternate carbon nanofoam inductor ACNFI filler and adhesive insulator. After the fill is cooled the whole part is removed from the cast halves and may be inspected, deburred, and/or finished.

The variable hydraulic preform slurry non ionic or electrolyte mechanically refined and nanoparticle dispersion high wear-heat resistant parts press FIG. 1 numbers 1 to 18. The 1—Hydraulic control wheel is connected to the 2—Electronic servo processor and allows the operator to expand and contract 7—Slurry non ionic and electrolyte tool steel press plate primarily to expand the 10—Slurry non ionic and electrolyte tool steel reservoir by moving the 1—Hydraulic control wheel in a fully counter clockwise fashion. This allows the operator to initiate a separate machine to pump Slurry non ionic and electrolyte into the 8—Slurry non ionic and electrolyte tool steel line in, subsequently to the 9—Gravity feed collector line out and finally to the 10—Slurry non ionic and electrolyte tool steel reservoir. Slurry non ionic and electrolyte is defined here as specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 55 elements and/or Specification 56 alloys manufactured preform slurry non ionic or electrolyte mechanically refined and nanoparticle high wear-heat resistant parts. After the 10—Slurry non ionic and electrolyte tool steel reservoir is filled the operator can electronically disengage or manually remove the manual stop control release pull pin. The operator then closes the 9B—Tool steel control to prepare for the extrusion. The operator would proceed by rotating the 1—Hydraulic control wheel in a clockwise fashion contracting the 7—Slurry non ionic and electrolyte tool steel press plate and forcing the Slurry non ionic and electrolyte comprised of non ionic or electrolyte mechanically refined and nanoparticle slurry formula into the 17—Tool steel extrusion die cast design internal cavity. The specified amount of Slurry non ionic and electrolyte is compressed to preform slurry non ionic or electrolyte mechanically refined and nanoparticle specification pressure measured in millibars Mb until the specified Slurry non ionic and electrolyte required to fill the 17—Tool steel extrusion die cast design internal cavity has been reached. The 1—Hydraulic control wheel is then locked until the 17—Tool steel extrusion die cast design internal cavity has been removed.

The 2—Electronic servo processor sends an electrical signal to the 3—Hydraulic pump of the 7—Slurry non ionic and electrolyte tool steel press plate position that is calibrated to the 1—Hydraulic control wheel.

The 3—Hydraulic pump receives an electrical signal from the 2—Electronic servo processor of the 7—Slurry non ionic and electrolyte tool steel press plate position that is calibrated to the 1—Hydraulic control wheel. The 3—Hydraulic pump pumps fluids to the 4—Hydraulic pipe.

The 4—Hydraulic pipe receives fluids from the 3—Hydraulic pump and conveys the fluids to the 5—Hydraulic actuator.

The 5—Hydraulic actuator receives fluids from the 4—Hydraulic pipe and the force from the fluids is transferred through the actuator as vertical up-and-down movement to an affixed 6—Hydraulic arm.

The 6—Hydraulic arm moves vertically up-and-down and forces the 7—Slurry non ionic and electrolyte tool steel press plate to expand and contract.

The 7—Slurry non ionic and electrolyte tool steel press plate is forced by the 6—Hydraulic arm to expand and contract.

The 8—Slurry non ionic and electrolyte tool steel line in receives Slurry non ionic and electrolyte from an external pump and conveys them to the 9A—Gravity feed tool steel collector. The 8—Slurry non ionic and electrolyte tool steel line in can be ionic process tool steel interface positive or negative electrode electronically charged for enhanced formulation.

The 9A—Gravity feed tool steel collector receives Slurry non ionic and electrolyte from the 8—Slurry non ionic and electrolyte tool steel line in and conveys them to the 10—Slurry non ionic and electrolyte tool steel reservoir.

The 10—Slurry non ionic and electrolyte tool steel reservoir receives Slurry non ionic and electrolyte from the 9A—Gravity feed tool steel collector line out.

After the 10—Slurry non ionic and electrolyte tool steel reservoir is filled the 9B—Tool steel control is utilized to close the opening to prepare for the extrusion and may be provisionally locked and stopped at any position.

The 11—Slurry non ionic and electrolyte reservoir regulated tool steel carbonaceous-polyamide waste filtration removes waste from the 10—Slurry non ionic and electrolyte tool steel reservoir while it is being filled with Slurry non ionic and electrolyte from common recovery distillation heated interface tool steel and thermometer gauge, ordinary atmospheric pressure, vacuum pump barometric pressure measured in millibars Mb, and fractional distillation all waste gases are processed to flu gas detoxification system.

The 12—Slurry non ionic and electrolyte reservoir expanded.

The 13—Slurry non ionic and electrolyte reservoir contracted.

The 14—Slurry non ionic and electrolyte reservoir brass or tool steel aperture and 15—Tool steel extrusion die cast design brass or tool steel fitting connects directly and conveys Slurry non ionic and electrolyte to the 17—Tool steel extrusion die cast design internal cavity. The 18—Tool steel extrusion die cast design internal cavity regulator carbonaceous-polyamide waste filtration and 18B—Tool steel vacuum release control and portal works in unison with the press plate drawing expanding and contracting Slurry non ionic and electrolyte removing waste from the 17—Tool steel extrusion die cast design internal cavity while it is being filled with Slurry non ionic and electrolyte from common recovery distillation heated interface tool steel and thermometer gauge, ordinary atmospheric pressure, vacuum pump barometric pressure measured in millibars Mb, and fractional distillation all waste gases are processed to flu gas detoxification system.

The 17—Tool steel extrusion die cast internal cavity is designed as a tool steel extrusion die cast mold for each highly pure naturally occurring carbon and allotropes of carbon filler and adhesive insulator part comprised of two master extrusion tool steel halves. This is accomplished by first utilizing engineering drafting and computer aided design with the most advanced tool steel part manufacture process and tool steel part machining techniques and/or by utilizing replacement ceramic molds specification 35 to supplement the development of extrusion die cast master design manufacture process with high purity tool steel die cast extrusion molds.

Highly pure naturally occurring carbon, hybrid allotropes of carbon, and alternate carbon nanofoam inductor ACNFI filler and adhesive insulator vacuum control of nitrogen, hydrogen, chlorine, ether, amino acid, or element dispersion brake pads, electronic brushes and parts require two master extrusions tool steel mold halves for each specification part. highly pure naturally occurring carbon, hybrid allotropes of carbon, and alternate carbon nanofoam inductor ACNFI filler and adhesive insulator parts precision casting molds requires a minimum two and a maximum of six master extrusion tool steel mold halves for each specification part.
highly pure naturally occurring carbon, hybrid allotropes of carbon, and alternate carbon nanofoam inductor ACNFI filler and adhesive insulator parts precision casting molds are utilized to manufacture highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator 1.0 to 2.5 phase extrusions and two to six master highly pure naturally occurring carbon, hybrid allotropes of carbon, and alternate carbon nanofoam inductor ACNFI filler and adhesive insulator mold halves per specification part.

The manufacture process of 1.0 to 2.5 phase extrusions and die cast design for highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator requires two to six master extrusion tool steel halves for each two to six reciprocal highly pure naturally occurring carbon, hybrid allotropes of carbon, and alternate carbon nanofoam inductor ACNFI filler and adhesive insulator master precision casting molds parts allowing two A and B highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator to be combined. The 0.5 phase extrusion equals two die cast mold halves both equal to or less than one half 0.5 phase extrusion molten pour.

The utility patent application specification concrete control room and monitoring station manufacturing in a complete vacuum and may supply rich oxygen from capillary feeders at varying points to the specified highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator part molten fill A and B fills up to four pours. The highly pure naturally occurring carbon, hybrid allotropes of carbon, and alternate carbon nanofoam inductor ACNFI filler and adhesive insulator half shell or 0.5 phase extrusion are designed and utilized for state of the art manufacture process when combining highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator in combination of layered foundry fills, parts may be sprayed and dipped non conductive adhesives insulator films, and all waste gases are processed to flu gas detoxification system.

The highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator is a layered greater than 0% to less than 100% alloy component A and greater than 0% to less than 100% alloy component B part that is created in combination of layered foundry fills by utilizing two to six master highly pure naturally occurring carbon, hybrid allotropes of carbon, and alternate carbon nanofoam inductor ACNFI filler and adhesive insulator parts precision casting molds per specification part by pouring molten fill as a layered alloying component highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator four molten metal or other fill pours equal to 1.0 to 2.5 phase extrusions.

The highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator is a layered greater than 0% to less than 100% highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator A component part, and greater than 0% to less than 100% highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator B component part created in combination of layered fills of two to six master highly pure naturally occurring carbon, hybrid allotropes of carbon, and alternate carbon nanofoam inductor ACNFI filler and adhesive insulator extrusion die cast mold halves equal to 1.0 to 2.5 phase extrusions.

Super carbon alloy is defined as allotropes of carbon sintered and/or smeltered foundry manufacture process of combined highly pure metal, super alloy, and/or element. The pre and post pour technological standard is accomplished with the utility patent application specification concrete control room and monitoring station manufacturing in a complete vacuum and may supply rich oxygen from capillary feeders at varying points and all waste gases are processed to flu gas detoxification system and includes nitrate, nitride, anodize, and benzotriazole, methyl, tolyltriazole, sodium chemical pre and post foundry treatment submersion bath flake and prill anticorrosive purification solution washing and screening table for the manufacture of copper and metals. Hot smelters prepare iron, manganese, lithium, cadmium, lead, nickel, copper, zinc, zirconium, aluminum, titanium, molybdenum, tungsten, or metal for die cast pours and are also utilized for layered foundry fills die cast pours of highly pure metal, super alloy, carbon, ceramics, acid solid, alkaline, glass, acrylic, synthetic polymer, halide, alkalide, nonconductive zirconia, allotropes of carbon, alternate carbon nanofoam inductor ACNFI, and impedance matching load or signal ceramic red brick clay insulator.

All mechanically refined metal ore may be sintered and/or smeltered element additive alloyed allotropes of carbon, tolyltriadole, sodium, benzotriadole, methyl, ammoniate, galvanize, anodize, nitrate, molybdenum, chromium, chromoloy, nitride, hydrochloric acid or combined alloyed sintered and/or smeltered highly pure metal, super alloy, alkaline, nonconductive zirconia, and impedance matching load or signal ceramic red brick clay insulator.

All metal ore may be sintered and/or smeltered for homogenization and specific melting point measured in degrees Celsius.

Finely screened grit size mechanically refined copper ore may be pre molten metal chemically treated manufacture process with tolyltriazole, sodium and benzotriazole, methyl, flake, and prill washing and screening table technique and chemical submersion bath for highly pure copper, brass, and bronze alloy anticorrosion purification process sequence.

Replacement ceramic cast 2.5 phase design extrusion die cast molding for super alloy.

The super alloy is a layered greater than 0% to less than 100% highly pure metal or super alloy and greater than 0% to less than 100% highly pure metal or super alloy part that is created by pouring molten metal into a cast mold over a process of 2.5 phase design extrusion that create four molded casts for each designed master steel part that is manually machined and manufactured named part X the external layer highly pure metal or super alloy and part Z the internal layer highly pure metal or super alloy.

This replacement mold application is for the manufactured process of 2.5 phase design extrusion that creates a single part identical to the master designed and machined manufactured part. The new part chemical element becomes a super alloy that is layered greater than 0% to less than 100% highly pure metal, super alloy, carbon, ceramics, acid solid, alkaline, glass, acrylic, synthetic polymer, halide, alkalide, nonconductive zirconia, allotropes of carbon, alternate carbon nanofoam inductor ACNFI, and impedance matching load or signal ceramic red brick clay insulator and greater than 0% to less than 100% highly pure metal, super alloy, carbon, ceramics, acid solid, alkaline, glass, acrylic, synthetic polymer, halide, alkalide, nonconductive zirconia, allotropes of carbon, alternate carbon nanofoam inductor ACNFI, and impedance matching load or signal ceramic red brick clay insulator.

The manufacture process begins by a designed and machined manufactured master part named part X. The master part X is used to create two external cast halves. This is accomplished by casting the master part X into the center of two ceramic molded halves with newly poured ceramic slip and then may be placed in a cool damp room and receive finish application with a wet sponge. After the ceramic cast dries the master part X is removed and the two ceramic molded halves are ignited and cured 3 hours in a kiln at 2000 degrees Fahrenheit or 12 hour interval day at 2000 degrees Fahrenheit.

The second master part named part Z is designed and machined manufactured greater than 0% to less than 100% less than tolerances that of the master part X or the external cast halves. The master part Z is used to create two internal cast halves. This is accomplished by casting the master part Z into the center of two ceramic molded halves with newly poured ceramic slip and then may be placed in a cool damp room and receive finish application with a wet sponge. After the ceramic cast dries the master part Z is removed and the two ceramic molded halves are ignited and cured 3 hours in a kiln at 2000 degrees Fahrenheit or 12 hour interval day at 2000 degrees Fahrenheit. After the two ceramic cast halves cool they are used separately to make two reciprocal extrusion halves by pouring ceramic slip into the recesses and joining both halves with new cast covers to dry.

The external tolerances of all of the four cast covers X and Z are identical opposing so that X and Z halves can be joined and prepared for two separate halves molten highly pure metal or super alloy fills. After the poured molten highly pure metal or super alloy cools both extruded halves are removed and stored. The remainder halves with highly pure metal or super alloy fills are then joined and prepared for a second molten fill of greater than 0% to less than 100% highly pure metal or super alloy.

After the highly pure metal or super alloy is cooled the whole part is removed from the cast halves and is inspected, deburred, and finished.

The 14—Slurry non ionic and electrolyte reservoir brass or tool steel aperture conveys Slurry non ionic or electrolyte mechanically refined and nanoparticle to the 17—Tool steel extrusion die cast design internal cavity. Slurry non ionic or electrolyte mechanically refined and nanoparticle samples are taken and photo spectrometry analyzed by optical absorption, Raman spectra, and scanning electron microscopy measured in nanometers Nm to enhance slurry formula.

The 16—Tool steel electronic servo processor or manual stop control release pull pin can be electronically disengaged or manually removed after the 10—Slurry non ionic and electrolyte tool steel reservoir is filled to begin the Slurry non ionic and electrolyte extrusion.

The 18—Tool steel extrusion die cast design internal cavity regulator carbonaceous-polyamide waste filtration removes waste from the 17—Tool steel extrusion die cast design internal cavity while it is being filled with Slurry non ionic and electrolyte. The 18—Tool steel extrusion die cast design internal cavity regulator carbonaceous-polyamide waste filtration and 18B—Tool steel vacuum release control with processing may utilize an external vacuum pump for required specifications specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 55 elements and/or Specification 56 alloys.

The manufacture process of preform slurry non ionic or electrolyte mechanically refined and nanoparticle high wear-heat resistant part is to cool it and/or dry it at room temperature in degrees Celsius or cure the part in a furnace typically for 5 to 20 minutes from 1076 degrees Fahrenheit to 3230 degrees Fahrenheit.

Preform slurry non ionic or electrolyte making of four sections 1. Preform slurry non ionic or electrolyte mechanically refined and nanoparticle high wear-heat resistant part 2. preform slurry non ionic or electrolyte mechanically refined and nanoparticle high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 3. preform slurry non ionic or electrolyte mechanically refined and nanoparticle high wear-heat resistant parts aerospace, automotive, and transportation brake calipers, rotors, pads, washers, spacers, shims, dowels, and bushings 4. preform slurry non ionic or electrolyte mechanically refined and nanoparticle high wear-heat resistant parts precision casting molds for the manufacturing of highly pure metal, super alloy, highly pure naturally occurring carbon, ceramics, optical silica alumina or molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, acid solids, alkaline, glass, acrylic, synthetic polymers, halide, alkalide, antimonide, nonconductive zirconia, allotropes of carbon, alternate carbon nanofoam inductor ACNFI, and impedance matching load or signal ceramic red brick clay insulators 1.0 to 2.5 phase extrusions two to six master preform slurry non ionic or electrolyte mechanically refined and nanoparticle high wear-heat resistant parts precision casting molds. All 2.5 phase extrusions and half shell castings are processed utility patent application specification concrete control room and monitoring station manufacturing in a complete vacuum and may supply rich oxygen from capillary feeders at varying points to molten elements in crucibles, and extrusion molds parts may be sprayed and dipped non conductive adhesives insulator films and all waste gases are processed to flu gas detoxification system.

Preform slurry non ionic or electrolyte mechanically refined and nanoparticle dispersion allotropes of carbon made by the variable hydraulic preform slurry non ionic or electrolyte mechanically refined and nanoparticle dispersion high wear-heat resistant parts press FIG. 1 numbers 1 to 18. Variable hydraulic preform slurry non ionic or electrolyte mechanically refined and nanoparticle dispersion high wear-heat resistant parts press with FIG. 1 numbers 1 to 18 specific components that conform to specified requirements to unique American Society for Testing and Materials International Standards Worldwide Identifiers. Variable hydraulic preform slurry non ionic or electrolyte mechanically refined and nanoparticle dispersion high wear-heat resistant parts press the center of the utility patent application specification slurry formula in three scientific forms of 6—Solids, 7—Liquids and 8—Gases Noble gaseous element Argon and other gaseous element specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 55 elements and/or Specification 56 alloys manufactured preform slurry non ionic or electrolyte mechanically refined and nanoparticle. high wear-heat resistant parts.

Utility patent application specification concrete control room and monitoring station manufacturing in a complete vacuum and may supply rich oxygen from capillary feeders at varying points to utility patent application specification for with die cast mold extrusion or printing hot smelters casting manufacturing of specified highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator including two to six master extrusion halves 1.0 to 2.5 phase extrusions per specification part molten foundry fill up to four pours and the manufacture process or assembly for each specification component or part thereof and all waste gases are processed to flu gas detoxification system.

Utility patent application specification concrete control room and monitoring station manufacturing in a complete vacuum and may supply rich oxygen from capillary feeders at varying points to utility patent application specification manufacturing of highly pure metal, super alloy, carbon, ceramics, acid solid, alkaline, glass, acrylic, synthetic polymer, halide, alkalide, nonconductive zirconia, allotropes of carbon, alternate carbon nanofoam inductor ACNFI, and impedance matching load or signal ceramic red brick clay insulator hot pouring casting printing with molten foundry fill of die cast mold precision casting of bars, rods, plates, sheets, foil, leaf, alumina, copper, wire, annealing, drawing, and spun coils and windings for electronic component, highly pure metal, super alloy drawing, annealing, and spinning process for wire, spun cable, interwoven rebar mesh with or without interwoven textile mesh heated or supercooled particulate matter synthetic and polymer resins carbonaceous-polyamide unit of measurement in gage manufacture process connector system super alloy die cast tool steel molten-forged crimping tool that works with molten-forged mesh connectors. Other construction tools include powders nitrate hardened nitride steel grit unit of measurement in mesh or grit size.

Utility patent application specification concrete control room and monitoring station manufacturing in a complete vacuum and may supply rich oxygen from capillary feeders at varying points to utility patent application specification 1.0 to 2.5 phase extrusions manufacturing of highly pure metal or super alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system.

Utility patent application specification concrete control room and monitoring station manufacturing in a complete vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath hydrochloric acid, ammonia from nitrogen, and hydrogen anticorrosive purification treatment and all waste gases are processed to flu gas detoxification system.

Utility patent application specification concrete control room and monitoring station manufacturing in a complete vacuum and may supply rich oxygen from capillary feeders at varying points to mechanically refined metal ore sintered and smeltered non metallic additive allotropes of carbon alloyed super alloy, steel super carbon steel, tungsten super carbon tungsten, or additive sintered and smeltered molybdenum for homogenization steel molybdenum steel, or tungsten molybdenum tungsten and all waste gases are processed to flu gas detoxification system.

Utility patent application specification manufacturing of highly pure metal, super alloy, carbon, ceramics, acid solid, alkaline, glass, acrylic, synthetic polymer, halide, alkalide, nonconductive zirconia, allotropes of carbon, alternate carbon nanofoam inductor ACNFI, and impedance matching load or signal ceramic red brick clay insulator 1.0 to 2.5 phase extrusions or half shell casted composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, super alloy, acid solid, alkaline, glass, acrylic, synthetic polymer, halide, alkalide, nonconductive zirconia, impedance matching load or signal ceramic red brick clay insulator, allotropes of carbon, or alternate carbon nanofoam inductor ACNFI six sides rectangle, or square, or three sides continuous rod or cylinder highly pure metal, super alloy, acid solid, alkaline, glass, acrylic, synthetic polymer, halide, alkalide, nonconductive zirconia, impedance matching load or signal ceramic red brick clay insulator, allotropes of carbon, or alternate carbon nanofoam inductor ACNFI, or three sides zircon, nitrate zircon, and nitrate silica with or without molecular reinforcements nanoparticle alumina and allotropes of carbon cutting tools, or two sides continuous for drill bits half shell casted tools measured in gage.

Utility patent application specification manufacturing of highly pure metal or super alloy die cast tool steel molten-forged crimping tool for rebar mesh manufacture process connector system, specific super alloy and tool steel parts that conform to specified requirements to unique American Society for Testing and Materials International Standards Worldwide Identifiers variable hydraulic preform slurry non ionic or electrolyte mechanically refined and nanoparticle dispersion high wear-heat resistant parts press FIG. 1 numbers 1 to 18 and tool steel tungsten die cast extrusion molds for with manufacturing highly pure metal, super alloy, acid solid, alkaline, glass, acrylic, synthetic polymer, halide, alkalide, nonconductive zirconia, impedance matching load or signal ceramic red brick clay insulator, allotropes of carbon, or alternate carbon nanofoam inductor ACNFI.

Utility patent application specification manufacture process of replacement ceramic precision casting molds specification 35 for with manufacturing highly pure metal, super alloy, acid solid, alkaline, glass, acrylic, synthetic polymer, halide, alkalide, nonconductive zirconia, impedance matching load or signal ceramic red brick clay insulator, allotropes of carbon, or alternate carbon nanofoam inductor ACNFI.

Utility patent application specification manufacture process of preform slurry non ionic or electrolyte mechanically refined and nanoparticle dispersion allotropes of carbon with or without ionic suspension element Specification 55 elements or Specification 56 alloys extrusion or casted highly pure metal, super alloy, allotropes of carbon with or without ionic suspension element Specification 55 elements, Specification 56 alloys, and alkaline, halide, antimonide, or alkalide, nonconductive zirconia, and impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink series and parallel circuits two positive and negative terminal poles commonly copper alloy measured in Volts, or of preform slurry non ionic or electrolyte alternate carbon nanofoam inductor ACNFI extrusion, or casted highly pure metal, super alloy, alternate carbon nanofoam inductor ACNFI, nonconductive zirconia, and impedance matching load or signal ceramic red brick clay insulator electronic part equivalent to one resistor, switch, relay, or electronic part inductor, antinode coupler, and ground series and parallel circuits two negative terminal poles commonly copper alloy measure in Ohms of inductor, antinode coupler, and ground or two positive and negative terminal poles commonly copper alloy measured in Volts. All electronic parts two sides casted conductive plate, sheet, foil, or leaf highly pure metal, super alloy, halide, antimonide, or alkalide rectangle, square, continuous rod or cylinder. Rectangle or square six sides, five sides nonconductive zirconia, impedance matching load or signal ceramic red brick clay insulator, allotropes of carbon, or alternate carbon nanofoam inductor ACNFI, plate, sheet, foil, or leaf casted insulated, and one side layered or non layered conductive highly pure metal, super alloy, and/or alkaline, halide, antimonide, or alkalide, plate, sheet, foil, or leaf casted conductive, or four sides nonconductive zirconia, impedance matching load or signal ceramic red brick clay insulator, allotropes of carbon, or alternate carbon nanofoam inductor ACNFI casted plate, sheet, foil, or leaf insulated, and two conductive highly pure metal, super alloy, and/or alkaline, halide, antimonide, or alkalide, plate, sheet, foil, or leaf casted series and parallel circuits and two positive and negative terminal poles commonly copper alloy measured in Volts or two negative terminal poles commonly copper alloy measured in Ohms to antinode coupler, or continuous rod or cylinder three sides, one continuous side nonconductive zirconia, impedance matching load or signal ceramic red brick clay insulator, allotropes of carbon, or alternate carbon nanofoam inductor ACNFI, plate, sheet, foil, or leaf casted insulated, and two sides conductive highly pure metal, super alloy, and/or alkaline, halide, antimonide, or alkalide, plate, sheet, foil, or leaf casted series and parallel circuits and two positive and negative terminal poles commonly copper alloy measured in Volts or two negative terminal poles commonly copper alloy measured in Ohms to antinode coupler preform slurry non ionic or electrolyte casted ionic suspension element allotropes of carbon battery cell outstanding one or two sides plate, sheet, foil, or leaf casted conductive highly pure metal, super alloy, halide, antimonide, or alkalide series and parallel circuits and two positive and negative terminal poles commonly copper alloy measured in Volts or two negative terminal poles commonly copper alloy measured in Ohms to antinode coupler or electronic parts requires one, or two, or more brushes in even intervals and two or more inductors and antinode couplers with one or two sides conductive plate, sheet, foil, or leaf casted highly pure metal, super alloy, halide, antimonide, or alkalide series and parallel circuits and two positive and negative terminal poles commonly copper alloy measured in Volts or two negative terminal poles commonly copper alloy measured in Ohms to antinode coupler.

Battery crucible casted or 1.0 to 2.5 phase extrusions highly pure metal or super alloy battery cells layered, spaced and casted conductive in series and parallel circuits even or odd interval number combinations varying complex, battery cells highly pure acid solid chemical and/or highly pure chemical alkali solid complex, crucible casted conductive or 1.0 to 2.5 phase extrusions highly pure metal or super alloy layered and interval spaced conductive in series and parallel circuits. Distillation reservoir specification manufactured all conservation of energy law insulated lightweight battery cold cell with or without gaseous element suspension halogens, antimony, highly pure ammonia, allotropes of carbon hydrogen carbon HC hydrocarbons compound with or without ionic suspension element allotropes of carbon, alternate carbon nanofoam inductor ACNFI, nanoparticle alumina, alumina, and ionic suspension element Specification 55 highly pure metals or ionic suspension element Specification 56 super alloys. Battery crucible casted conductive or 1.0 to 2.5 phase extrusions highly pure metal or super alloy layered, and interval spaced series and parallel circuits and/or complex, continuous sheets cut films insulate, crucible casted conductive or 1.0 to 2.5 phase extrusions variable hydraulic preform slurry non ionic silicate alumina allotropes of carbon dispersion high wear-heat compression resistant light weight battery cells. Highly pure alkali silica, alumina, nanoparticle alumina, or elements lithium, cadmium, nickel, lead, copper, Specification 55 elements or Specification 56 alloys. One by one each battery cell crucible casted non conductive or submersion bath synthetic polymer sealed control room vacuum protocol manufacture process. Motor frame protected by synthetic woven textile fiber, silica fiber high heat-resistant insulator shielding, continuous sheets cut films insulate, preform slurry non ionic silicate allotropes of carbon dispersion high wear-heat compression resistant light weight insulator, and/or or high tensile strength super alloy woven textile shielding. One by one each battery cell crucible casted or submersion bath synthetic polymer sealed control room vacuum protocol manufacture process. All four conductive or non conductive heat-wear high tensile strength and compression resistant insulators made in light makeweight monocombe design series 2π radians or one full turn and right angles corrugated compartmented techniques composite combinations thermoplastic sealed, layered or woven shielded.

Motor crucible casted or 1.0 to 2.5 phase extrusions highly pure metal or super alloy composite coils, composite windings, and alumina, copper, wire annealing, drawing, and spun coils, highly pure metal, super alloy drawing and annealing process for wire. Motor composite coils, composite windings commonly copper or super alloy include continuous or numeric interval mechanical advantage spools series and parallel conversion order shapes of rod, cylinder, sphere, rectangle, or square crucible casted or 1.0 to 2.5 phase extrusions. Motor electronic components brushes allotropes of carbon with or without ionic suspension elements each brush alternate carbon nanofoam inductors, and antinode coupler continuous or numeric alternating current AC electronic load supply ramps positive and negative terminal measured in Volts and monitors positive and negative terminal measured in Volts and negative and negative terminal poles commonly copper alloy measure in Ohms of inductor, antinode coupler, and ground series and parallel circuits. Spun numeric wrapped super alloy copper wire are synthetic polymer dipped or protected synthetic woven fibers, silica woven fibers, or high tensile strength super alloy allotropes of carbon shielding. Motor frame protected by synthetic woven textile fiber, silica fiber high heat-resistant insulator shielding, continuous sheets cut films insulate, preform slurry non ionic silicate allotropes of carbon dispersion high wear-heat compression resistant light weight insulator, and/or or high tensile strength super alloy woven textile shielding. One by one all composite or wire motor coils and windings are crucible casted or submersion bath synthetic polymer sealed control room vacuum protocol manufacture process. Three heat-wear high tensile strength, continuous sheets cut films insulate and variable hydraulic preform slurry non ionic allotropes of carbon dispersion high wear-heat compression resistant light weight insulators made Series of right angles 2π radians or one full turn the sum of the exterior angles form convex regular polygons corrugated and compartmented architecture techniques monocombe shapes of triangle square pentagon hexagon heptagon octagon and nonagon and right angle combinations light makeweight design. Crucible casted or 1.0 to 2.5 phase extrusions motor rods, bearings, casings, housings, and assemblies are manufactured and assembled.

One and two or more star systems order of the universe or well-lit source radiate light onto parallel 1—optical glass lens and 2—lightweight universal spectra camera and monitor panel shell numeric horizontal and vertical sectors receiving light of added and subtracted magnification and telescopic lenses travelling to scientific mirrors reflecting light onto ˜1.25-inch analogous scanning photo chemical electron molecule film and 2—numeric horizontal and vertical sectors ˜10 inch lightweight universal spectra camera and monitor linearized panel shell integrated or polarized alignment numeric optical lenses, glass beads, and polymer gels form scientific optical light reception and identification receiving emissions of light added and subtracted magnification and telescopic lenses transposed onto analogous scanning photo chemical electron molecule enriched conductive allotropes of carbon, alumina nanoparticles, copper nanoparticles, colloidal gold, silver nanoparticles, iron nanoparticles, element nanoparticles and platinum nanoparticles series and parallel circuit film element and complex element acid, base, alkyl, ionic and non ionic film enriched conductive acid, base, alkyl, ionic, non ionic, element and enriched complex element cells occupying vertical and horizontal segments equal to photo graphic picture resolution. Two sided panel shell thermoelectrically sealed vertical and horizontal sectors in series and parallel circuits highly pure metal alumina atomic symbol Al number 13 annealing, drawing, and spun fine wire or press rolled flat strips fine wire and shielding analogous scanning photo chemical electron molecule enriched conductive emissions allotropes of carbon, alumina nanoparticles, copper nanoparticles, colloidal gold, silver nanoparticles, iron nanoparticles, element nanoparticles and platinum nanoparticles series circuit waveform generation symbol light of CMY cyan, magenta, yellow, RGB red, green, blue, and analogous scanning photo chemical electron molecule enriched conductive emissions allotropes of carbon, alumina nanoparticles, copper nanoparticles, colloidal gold, silver nanoparticles, iron nanoparticles, element nanoparticles and platinum nanoparticles series circuit waveform generation symbol light of alternate carbon nanofoam inductor ACNFI atomic number 6 symbol C pure light, filtered light, colored light and reflective light wavelength frequency received in nanoseconds processing by central processing unit CPU wavelength shift generator frequency counter and frequency analyzer order of central processing unit CPU wavelength shift generator added and subtracted changes order of wavenumber data output nanoseconds processor spectra wavelength frequency pure light, filtered light, colored light, and reflective light electronic data random access memory RAM and writable random access memory WRAM compact disc. The universal spectra camera and monitor glass bead molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications cables light emissions wavelength frequency light filtered light identification and photo active chemical electron molecule element scanning analogous series and parallel alumina atomic symbol Al and number 13 wire and shielding +/−wavelength shift generator medium random access memory RAM and writable random access memory WRAM compact disc data streams series viewing of the universal spectra camera and monitor panel shell thermoelectrically sealed sectors numeric 1—highly pure mineral or complex element electrolyte Liquid crystal mineralization methane light emitting diode LED and 2—symbol generator light optical reflective beads reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, Liquid crystal mineralization methane light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, and Liquid crystal mineralization light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors series and parallel highly pure metal alumina atomic symbol Al number 13 annealing, drawing, and spun fine wire or press rolled flat strips fine wire and shielding equal to vertical and horizontal picture resolution. Chlorophyll A ionic or anionic 2-parts 1+positive and 1−negative enriched chemical electron molecules and B ionic or anionic 2-parts 1+positive and 1−negative enriched chemical electron molecules photo active chemical electron molecule element film cells in series and parallel circuits Chlorophyll A ionic or anionic 2-parts 1+positive and 1−negative enriched chemical electron molecules and B ionic or anionic 2-parts 1+positive and 1−negative enriched chemical electron molecules photo active chemical electron molecule element film cells emissions in wavelength frequency counter and analyzer order of photo emissions light filtered light identification scanning analogous photo active chemical electron molecule element film cells circuits data output +/−wavelength shift generator. The CMY cyan, magenta, yellow, RGB red, green, blue, and alternate carbon nanofoam inductor ACNFI atomic number 6 symbol C pure light, filtered light, colored light and reflective light wavelength frequency received in nanoseconds processing by central processing unit CPU wavelength shift generator frequency counter and frequency analyzer order of central processing unit CPU wavelength shift generator added and subtracted changes of the order of wavenumber data output nanoseconds processor spectra wavelength frequency pure light, filtered light, colored light, and reflective light data streams series viewing sectors numeric 1—highly pure mineral or complex element electrolyte Liquid crystal mineralization methane light emitting diode LED and 2—symbol generator light optical reflective beads reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, Liquid crystal mineralization methane light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, and Liquid crystal mineralization light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors series and parallel highly pure metal alumina atomic symbol Al number 13 annealing, drawing, and spun fine wire or press rolled flat strips fine wire and shielding equal to the vertical and horizontal picture resolution. Two sided panel shell consists numeric sums of reflected delineations occupying vertical and horizontal segments equal to photo graphic picture resolution of integrated or polarized greater than high temperatures ˜1700° C. and 2200° C. crystalline silica optical reflective glass beads spectra light filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Similarly greater than high temperatures ˜1700° C. and 2200° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Liquid dispersion supersaturated liquids of condensation-nuclei matters two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective beads emissions of light spectra wavelength frequency onto optical reflective cables process in nanoseconds spectra wavelength frequency to central processing unit CPU wavelength shift and light symbol generator frequency counter and frequency analyzer order of wavelength frequency added and subtracted changes order of wavenumber data output in nanoseconds processing spectra wavelength frequency and light symbol generation pure light, filtered light, colored light, and reflective light and electronic data output random accessible memory RAM and writable random accessible memory WRAM compact disc. Two sided panel shell consists numeric sums of reflected centers occupying vertical and horizontal segments equal to photo graphic picture resolution of integrated or polarized greater than high temperatures ˜1700° C. and 2200° C. crystalline silica optical reflective glass beads spectra light filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Similarly greater than high temperatures ˜1700° C. and 2200° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Liquid dispersion supersaturated liquids of condensation-nuclei matters two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective beads emissions of light spectra wavelength frequency onto optical reflective cables process in nanoseconds spectra wavelength frequency to central processing unit CPU wavelength shift and light symbol generator frequency counter and frequency analyzer order of wavelength frequency added and subtracted changes order of wavenumber data output in nanoseconds processing spectra wavelength frequency and light symbol generation pure light, filtered light, colored light, and reflective light and electronic data output random accessible memory RAM and writable random accessible memory WRAM compact disc. Two sided panel shell consists numeric sums of reflective centers of integrated or polarized greater than high temperatures ˜1700° C. and 2200° C. crystalline silica optical reflective glass beads spectra light filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Similarly greater than high temperatures ˜1700° C. and 2200° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Liquid dispersion supersaturated liquids of condensation-nuclei matters two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective cables emissions of light spectra wavelength frequency symbol generator light onto optical reflective beads processed in nanoseconds spectra wavelength frequency from central processing unit CPU wavelength shift and light symbol generator frequency counter and frequency analyzer order of wavelength frequency added and subtracted changes order of wavenumber data output in nanoseconds processing spectra wavelength frequency and light symbol generation pure light, filtered light, colored light, and reflective light emissions output. The KIOSK universal spectra camera and monitor panel shell thermoelectrically sealed vertical and horizontal sectors numeric 1—highly pure mineral or complex element electrolyte Liquid crystal mineralization methane light emitting diode LED and 2—symbol generator light optical reflective beads reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications'beads, gels, cables, lenses, mirrors, visors and panels glass bead, Liquid crystal mineralization methane light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, and Liquid crystal mineralization light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors integrated or polarized alignment optical high purity panel, molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels gels finished touch screen kiosk in series circuits highly pure metal alumina atomic symbol Al number 13 annealing, drawing, and spun fine wire or press rolled flat strips fine wire and shielding receiving negative electron molecules wavelength frequency alternate carbon nanofoam inductor ACNFI touch screen kiosk sensory cells panel shell thermoelectrically sealed vertical and horizontal sectors series circuits highly pure metal alumina atomic symbol Al number 13 annealing, drawing, and spun fine wire or press rolled flat strips fine wire and shielding process in nanoseconds negative electron molecules wavelength frequency to central processing unit CPU wavelength generator added and subtracted changes of the order of wavenumber data output nanoseconds processor negative electron molecules wavelength frequency. Keyboard computing device typewriter-style arrangement of keys supplied by a central processing unit CPU processor made up of a manual mechanical arrangement of keys in series and parallel circuits occupying a horizontal plane with various ports, and plug-ins connectivity. Keyboard key parts in series and parallel analogous circuits of enriched highly pure metal molecular copper atomic symbol Cu and number 29, and alumina atomic symbol Al number 13 annealing, drawing, and spun fine wire or press rolled flat strips fine wire and shielding receiving negative electron molecules wavelength frequency keys from keyboard process in nanoseconds electron molecules wavelength frequency keys to central processing unit CPU processor wavelength generator added and subtracted changes of the order of wavenumber data output nanoseconds processing electron molecules wavelength frequency keys identification and series medium random access memory RAM and writable random access memory WRAM compact disc data streams +/−connectivity. The keys consist of and not limited Arabic number keys 0, 1, 2, 3, 4, 5, 6, 7, 8, and 9, various symbol keys transposed on top of number keys !, @, #, $, %, ̂, &, *, (, and ), various symbol keys occupy their own keys and keys transposed on to of various symbol keys -, =, [, ], \, ;, ', ,, ., /, ′, _, +, {, }, |, :, ″, <, >, ?, and ˜, The International Organization for Standardization ISO basic Latin-script alphabet consists of the following 26 letters alphabet keys in upper-case Q, W, E, R, T, Y, U, I, O, P, A, S, D, F, G, H, j, K, L, Z, X, C, V, B, N, and M, alphabet key in lower-case q, w, e, r, t, y, u, I, o, p, a, s, d, f, g, h, j, k, l, z, x, c, v, b, n, and m, function specific keys space bar, enter, escape, shift, tab, alternate, escape, control, number lock, caps lock, backspace, right arrow, left arrow, up arrow, down arrow, all direction arrow, page-up, page-down, control, function, consecutive Function F1 to F12, home, end, pause, insert, and delete. The pure light, filtered light, colored light, and reflective light data output spectra wavelength frequency is received by central processing unit CPU wavelength shift generator printer of pure light, filtered light, colored light, and reflective light supersaturated particulate matter colored and shaded scale pigments natural polymer-carbonaceous inks, toner powders and printed films.

Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 55 Elements spectrum. Formula enhanced molten diffusion mechanically shattered chards and refined particulate matter PM Sio² gaseous suspension are drawn into heated 2200° C. molten diffusion C-6 allotropes of carbon reservoir flash forming carbonaceous-silica Si+C6 allotropes of carbon is SiC silica allotropes of C6 carbon or Sio²+2C6 (s) is SiC6 (s)+2O (g) thus allotropes of carbon Silicon-C6 is formed, formula enhanced molten diffusion mechanically shattered chards, refined or nanoparticle particulate matter PM Sio² and al13 gaseous suspension are drawn into heated 2200° C. molten diffusion C-6 allotropes of carbon reservoir flash forming carbonaceous-alumina silica Si+al13+C6 allotropes of carbon al13 alumina is Sial13C silica allotropes of carbon al13 alumina or Sio²+al13+2C6 (s) is SiC6al13 (s)+2O (g) thus allotropes of carbon alumina Silicon-C6al13 is formed. Vacuum or compression variable hydraulic press plate and pump specification gaseous negative or positive pressure in atmospheres mechanically refined and nanoparticle molecules, vacuum gaseous distillation reservoir mechanically refined and nanoparticle molecule transfer and mixing compounds, and vacuum gaseous mechanically refined and nanoparticle molecule preparation for control room casting, molding, sintering, and smeltering. Additional distillation reservoir dioxide CO₂ and carbon monoxide CO gaseous super alloy super cooling refrigeration molten diffusion particulate matter PM quenching by vacuum pump and super alloy curved or linear expression comprising a scientific aperture, a divergence measured in angulation, and a scientific aperture diffusive gaseous particle vacuum pump negative pressurized stream accelerator super cooling refrigeration deceleration and distillation reservoir supercooled quenching variable hydraulic press plate less than normal atmospheric with or without negatively pressurized distillation reservoir gaseous molecular diffusion and super alloy heated interface tool steel or supercooled temperature deceleration carbon dioxide CO₂ and carbon monoxide CO fractional distillation hybridizations that may releasing oxides of O₂ and O₁. Distillation reservoir with or without Multi waveform laser X, Y, Z field alignment carbon dioxide CO₂ and carbon monoxide CO ablation and fractional distillation synthesizing. Distillation processing particulate matter PM with or without Carbon dioxide CO₂ and Carbon Monoxide CO are vacuum pump distillation reservoir negatively charged—allotropes of carbon electron molecule electrolysis processed and reinforced with extenders and fillers negatively charged—allotropes of alternate carbon nanotube inductor ACNTI particles. The distillation reservoir may contain of a gaseous mixture consisting of carbon dioxide CO₂, carbon monoxide CO, oxides O₂, oxides O₁, and negatively charged—allotropes of alternate carbon nanotube inductor ACNTI particles. Specification of particulate matter PM carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent, carbonaceous-polyamide, crystalline silica optical, crystalline silica synthetic polymer optical, crystalline silica cellulosic natural polymer, and crystalline silica cellulosic rubber natural polymer optical filtered and non filtered specifications negative charging chemical electron molecule electrolysis drawing and spinning, solution Liquid or gaseous quenching, vacuum processing evaporation and carbonaceous-polyamide, crystalline silica optical, crystalline silica synthetic polymer optical, crystalline silica cellulosic natural polymer, and crystalline silica cellulosic rubber natural polymer optical filtered and non filtered specifications high molecular-weight carbonaceous particulate matter PM in condensation-nuclei type size particles measure in microns Symbol μ lower-case letter mu metric SI equivalent fine beads are collected and vacuum packed sealed for secondary phase Function-specific optical properties manufacturing, and carbonaceous-polyamide beads vacuum packed sealed for fiberaceous filament yarn and thread Function-specific properties manufacturing. Universal pulp agro-fiberaceous cellulosic filaments and subsequent fatty acids and oils extractions cellulosic natural polymers using common distillation processing techniques. The primary agro-fiberaceous filaments sought come from agro-fiberaceous waste materials hulls, husks, pits, straw, and peels. The end resultant filament is assorted lipid, lignin, liber, linnet and viscose. Characteristics and carbonaceous products of these woody plants are extracting cellulosic filaments for specification formula non ionic or electrolyte acid, base, or alkyl distillation reservoir specification vacuum processing scientific electrolysis covalent bonding sequence drawing and spinning formula solutions mechanically refined and nanoparticle dispersion continuous spinning yarn and thread and subsequent textile manufacturing. The process begins with collecting and pulverizing-shredding in specification mesh sizes massive tonnage of agro-fiberaceous waste materials hulls, husks, pits, straw, and peels. The massive tonnage is batch processed exposure to steam begins cellulosic extractions and convections under ordinary atmospheric pressure, quenching, evaporation, condensing, solution purifying electrolysis particle separations, and chemical pH probe. From here due the complexity of the blend agro-fiberaceous materials follows a simple sequence in order of distillation techniques with varying applications of aging oxidation agents, solution oxidations, solution and vacuum pumping extraction, centrifuge and electrolysis spinning separation, electron molecule positive and negative electrolysis preparations, steam extractions, pH probe, solution spinning and drawing electrolysis, cooling, chopping continuous filament yarn immersion pressing, aging reagents, pH probe, dissolving, filtering, ripening, simple alloy or steel simple acid chemical extrusion, electrolysis solution spinning drawing and spinning filaments, wet process and gaseous purification, bleaching with chloride, ultra-violet UV lamps, or Sunlight, dying with pigments, filament yarn washing, cutting, drying, specialized vacuum packing and storage.

Specification Periodic Table Element Groups Alkali Metals, Alkalide Earth Metals, Transition Metals, Other Metals, Metalloids, Non-Metals, Halogens, Noble Gases, and Rare Earth Element here in atomic number, element symbols, and names 3—Li—Lithium, 4—Be—Beryllium, 5—B—Boron, 12—Mg—Magnesium, 13—Al—Aluminum, 21—Sc—Scandium, 22—Ti—Titanium, 23—V—Vanadium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 32—Ge—Germanium, 33—As—Arsenic, 37—Rb—Rubidium, 38—Sr—Strontium, 39—Y—Yttrium, 40—Zr—Zirconium, 41—Nb—Niobium, 42—Mo—Molybdenum, 43—Tc—Technetium, 44—Ru—Ruthenium, 45—Rh—Rhodium, 46—Pd—Palladium, 47—Ag—Silver, 48—Cd—Cadmium, 49—In—Indium, 50—Sn—Tin, 51—Sb—Antimony, 52—Te—Tellurium, 55—Cs—Cesium, 56—Ba—Barium, 57—La—Lanthanum, 58—Ce—Cerium, 59—Pr—Praseodymium, 60—Nd—Neodymium, 61—Pm—Promethium, 62—Sm—Samarium, 63—Eu—Europium, 64—Gd—Gadolinium, 65—Tb—Terbium, 66—Dy—Dysprosium, 67—Ho—Holmium, 68—Er—Erbium, 69—Tm—Thulium, 70—Yb—Ytterbium, 71—Lu—Lutetium, 72—Hf—Hafnium, 73—Ta—Tantalum, 74—W—Tungsten, 75—Re—Rhenium, 76—Os—Osmium, 77—Ir—Iridium, 78—Pt—Platinum, 79—Au—Gold, 80—Hg—Mercury, 81—Tl—Thallium, 82—Pb—Lead, 83—Bi—Bismuth, 84—Po—Polonium, 85—At—Astatine, 87—Fr—Francium, 88—Ra—Radium, 89—Ac—Actinium, 90—Th—Thorium, 91—Pa—Protactinium, 92—U—Uranium, 93—Np—Neptunium, 94—Pu—Plutonium, 95—Am—Americium, 96—Cm—Curium, 97—Bk—Berkelium, 98—Cf—Californium, 99—Es—Einsteinium, 100—Fm—Fermium, 101—Md—Mendelevium, 102—No—Nobelium, 103—Lr—Lawrencium, 104—Rf—Rutherfordium, 105—Db—Dubnium, 106—Sg—Seaborgium, 107—Bh—Bohrium, 108—Hs—Hassium, 109—Mt—Meitnerium, 110—Ds—Darmstadtium, 111—Rg—Roentgenium, 112—Cn—Copernicium, 113—Uut—Ununtrium, 114—Uuq—Ununquadium, 115—Uup—Ununpentium, 116—Uuh—Ununhexium, 117—Uus—Ununseptium, and/or 118—Uuo—Ununoctium.

Specification Alloys metallurgy substances that are a mixture of two or more metals, or of a metal with a nonmetallic material not limited to Aluminum Alloys AA-8000 used for building wire, Al—Li aluminum, lithium, sometimes mercury, Alnico aluminum, nickel, copper, Duralumin copper, aluminum, Magnalium aluminum, 5% magnesium, Magnox magnesium oxide, aluminum, Nambe aluminum plus seven other unspecified metals, Silumin aluminum, silicon, and Zamak zinc, aluminum, magnesium, copper, Aluminum forms other complex alloys with magnesium, manganese, and platinum. Bismuth Alloys Wood's metal bismuth, lead, tin, cadmium, Rose metal bismuth, lead, tin, Field's metal, and Cerrobend. Cobalt Alloys Megallium, and Stellite cobalt, chromium, tungsten or molybdenum, carbon Talonite cobalt, chromium. Ultimet cobalt, chromium, nickel, molybdenum, iron, tungsten, and Vitallium. Copper Alloys Arsenical copper, Beryllium copper, beryllium, and Billon copper, silver. Brass copper, zinc, Calamine brass copper, zinc, Chinese silver copper, zinc, Dutch metal copper, zinc, Gilding metal copper, zinc, Muntz metal copper, zinc, Pinchbeck copper, zinc, Prince's metal copper, zinc, and Tombac copper, zinc. Bronze copper, tin, aluminum or other element, Aluminum bronze copper, aluminum, Arsenical bronze copper, arsenic, Bell metal copper, tin, Florentine bronze copper, aluminum or tin, Glucydur beryllium, copper, iron, Guanin likely a manganese bronze of copper, manganese, with iron sulfides and other sulfides, Gunmetal copper, tin, zinc, pHosphor bronze copper, tin and phosphorus, Ormolu Gilt Bronze copper, zinc, and Speculum metal copper, tin. Constantan copper, nickel, Copper-tungsten copper, tungsten, Corinthian bronze copper, gold, silver, Cunife copper, nickel, iron, Cupronickel copper, nickel, Cymbal alloys Bell metal copper, tin, Devarda's alloy copper, aluminum, zinc, Electrum copper, gold, silver, Hepatizon copper, gold, silver, Heusler alloy copper, manganese, tin, Manganin copper, manganese, nickel, Nickel silver copper, nickel, Nordic gold copper, aluminum, zinc, tin, Shakudo copper, gold, and Tumbaga copper, gold. Gallium Alloys Galinstan gallium, indium, tin. Gold Alloys Electrum gold, silver, copper, Tumbaga gold, copper, Rose gold, copper, and White gold, nickel, palladium, or platinum. Indium Alloys Field's metal indium, bismuth, tin. Iron or Ferrous Alloys Steel carbon Stainless steel chromium, nickel, AL-6XN, Alloy 20, Celestrium, Marine grade stainless, Martensitic stainless steel, and Surgical stainless steel chromium, molybdenum, nickel. Silicon steel silicon, Tool steel tungsten or manganese, Bulat steel, Chromoly chromium, molybdenum, Crucible steel, Damascus steel, HSLA steel, High speed steel, Maraging steel, Reynolds 531, and Wootz steel. Iron Anthracite iron carbon, Cast iron carbon, Pig iron carbon, and Wrought iron carbon. Fernico nickel, cobalt, Elinvar nickel, chromium, Invar nickel, Kovar cobalt, and Spiegelseisen manganese, carbon, silicon. Ferroalloys Ferroboron, Ferrochrome chromium, Ferromagnesium, Ferromanganese, Ferromolybdenum, Ferronickel, Ferrophosphorus, Ferrotitanium, Ferrovanadium, and Ferrosilicon. Lead Alloys Antimoniallead, antimony, Molybdochalkos lead, copper, Solder lead, tin, Terne lead, tin, and Type metal lead, tin, antimony. Magnesium Alloys Magnox magnesium, aluminum T—Mg—Al—Zn Bergman phase, and Elektron. Mercury Alloys Amalgam mercury and other metal except platinum. Nickel Alloys Alumel nickel, manganese, aluminum, silicon, Chromel nickel, chromium, Cupronickel nickel, bronze, copper, German silver nickel, copper, zinc, Hastelloy nickel, molybdenum, chromium, sometimes tungsten, Inconel nickel, chromium, iron, Monel metal copper, nickel, iron, manganese, Mu-metal nickel, iron, Ni—C nickel, carbon, Nichrome chromium, iron, nickel, Nicrosil nickel, chromium, silicon, magnesium, Nisil nickel, silicon, and Nitinol nickel, titanium, shape memory alloy. Potassium Alloys KLi potassium, lithium, and NaK sodium, potassium. Rare Earth Alloys Mischmetal various rare earths. Silver Alloys Argentium sterling silver, copper, germanium, Billon copper or copper bronze, sometimes with silver, Britannia silver, copper, Electrum silver, gold, Goloid silver, copper, gold, Platinum sterling silver, platinum, Shibuichi silver, copper, and Sterling silver, copper. Tin Alloys Britannium tin, copper, antimony, Pewter tin, lead, copper, and Solder tin, lead, antimony. Titanium Alloys Beta C titanium, vanadium, chromium, other metals, and 6al-4v titanium, aluminum, vanadium. Uranium Alloys Staballoy depleted uranium with titanium or molybdenum, and Uranium may also be alloyed with plutonium. Zinc Alloys Brass zinc, copper, and Zamak zinc, aluminum, magnesium, copper. Zirconium Alloys Zircaloy zirconium and tin, sometimes with niobium, chromium, iron, nickel.

1. A cool complete vacuum draws any one particulate matter while fluxing gaseous suspension creates the partial vacuum causing atmospheric suspension particulate matter diffusion equal particle distribution or saturation. Number 1. A prepared heated specification particulate matter partial vacuum fluxing suspension distillation reservoir continually extracting expanded higher temperature particulate matter melts the instantaneous creation of particulate matter parts of any two or more particulate matter materials resultant compound particulate matters. Number 2. The specification making of particulate matter extremely high optical grade silicon filtered and non filtered, high optical grade allotropes of carbonaceous-silicon particulate matter, high optical grade allotropes of carbonaceous-silicon particulate matter polyamides synthetic resins, high optical grade silicon filtered and non filtered polyamides synthetic resins, potassium ash and feldspar K 19, gypsum CaSO4.2H2O 20, zirconium Zr 40, S 16 quartz-bearing basalt Ca 20, cobalt Co 27, silica dioxide SiCO₂, sodium oxide NaO₂, calcium oxide CaO, polyethylene, synthetic polymer resins, hybrid allotropes of carbon, molecular silica hybrid allotropes of carbon molecular dioxide SiCO₂, molecular sodium oxide NaO₂ compound, molecular calcium oxide CaO, alkalines with or without magnesium Mg powdered resins, alternate carbon nanofoam inductor ACNFI, molecular and nanoparticle alumina Al13, fluoride F, Specification 55 elements, natural cellulosic polyamides resins, natural cellulosic polyamide rubber resins, natural carbonaceous resins, allotropes of carbonaceous nanoparticles, and natural cellulosic fiberaceous resins, allotropes of carbonaceous-silicon particulate matter cement clinkers and sands, high tensile strength heat resistant allotropes of carbonaceous-metals, allotropes of carbonaceous-polyamides synthetic resins, extremely hard heat resistant heavy mineral cement clinkers and sands, fine minerals and sands, ceramic red brick clay impedance matching load or signal insulators, and complex alkaline and acid powders. Number 3. The specification making of supersaturated particulate matter under and above normal atmospheric pressure measured in atmospheres and bars of pressure two or more particulate matter materials supercooled 0° C. or 32° F. interface tool steel, and specification acid, bases, and alkyls gaseous partial and complete suspensions of preform slurry non ionic or electrolyte forming as a naturally occurring phenomenon named cloud condensation nuclei or CCNs also known as cloud seeds are small particles typically 0.2 μm, or 1/100th the size of the average cloud droplet. The liquid vapor requires a non-gaseous surface to make the transition from a vapour to a liquid. The supercooled liquids of condensation nuclei particulate matter one and two or more condensation nuclei particulate matter materials resultant condensation nuclei particulate matters maybe electrolysis spun, drawn, evaporated, dispersed, casted, extruded and formed into resin powders. The liquids of condensation nuclei particulate matter materials maybe continuously solution processed into silicon gels with or without potassium ash and feldspar K 19, gypsum CaSO4.2H2O 20, zirconium Zr 40, S 16 quartz-bearing basalt Ca 20, cobalt Co 27, silica dioxide SiCO₂, sodium oxide NaO₂, calcium oxide CaO, carbon dioxide CO₂, synthetic polymer resins, hybrid allotropes of carbon and molecular dioxide CO₂ compound, molecular silica hybrid allotropes of carbon molecular dioxide SiCO₂ compound, molecular sodium oxide NaO₂ compound, and molecular calcium oxide CaO, alkalines with or without magnesium Mg powdered resins, alternate carbon nanofoam inductor ACNFI, molecular and nanoparticle alumina Al13, fluoride F, Specification 55 elements, natural cellulosic polyamides resins, natural cellulosic polyamide rubber resins, natural carbonaceous resins, allotropes of carbonaceous nanoparticles, and natural cellulosic fiberaceous resins drawn annealing print rolled films sheets, cut strips, spun wire line, spinning yarn and thread insulates.

2. Preform slurry non ionic or electrolyte mechanically refined and nanoparticle dispersion allotropes of carbon made by variable hydraulic preform slurry non ionic or electrolyte mechanically refined and nanoparticle dispersion high wear-heat resistant parts press The variable hydraulic press and distillation reservoir manufacture process scientific formula non ionic or electrolyte mechanically refined and nanoparticle, allotropes of carbon dispersion preform slurry extrusion, with or without ionic suspension element for manufactured preform slurry high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, electronic resistors, transformers, transducers, rectifiers, power supplies, or heat, preform slurry high wear-heat resistant parts aerospace, automotive, and transportation brake calipers, rotors, pads, and bushings, preform slurry non ionic or electrolyte mechanically refined and nanoparticle high wear-heat resistant parts precision casting molds 2.5 phase die cast molding and covalent bonding sequence drawing and spinning formula solutions mechanically refined and nanoparticle dispersion fine concrete, mortar, brick, and tiles. The variable hydraulic preform slurry non ionic or electrolyte mechanically refined and nanoparticle dispersion high wear-heat resistant parts press with FIG. 1 numbers 1 to 18 specific components that conform to specified requirements to unique American Society for Testing and Materials International Standards Worldwide Identifiers. Variable hydraulic preform slurry non ionic or electrolyte mechanically refined and nanoparticle dispersion high wear-heat resistant parts press the center of the utility patent application specification slurry formula in three scientific forms of 6—Solids, 7—Liquids and 8—Gases Noble gaseous element Argon and other gaseous element specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 55 elements and/or Specification 56 alloys manufactured preform slurry non ionic or electrolyte mechanically refined and nanoparticle high wear-heat resistant parts. The variable hydraulic preform slurry non ionic or electrolyte mechanically refined and nanoparticle dispersion high wear-heat resistant parts press FIG. 1 numbers 1 to 18. The 1—Hydraulic control wheel is connected to the 2—Electronic servo processor and allows the operator to expand and contract 7—Slurry non ionic and electrolyte tool steel press plate primarily to expand the 10—Slurry non ionic and electrolyte tool steel reservoir by moving the 1—Hydraulic control wheel in a fully counter clockwise fashion. This allows the operator to initiate a separate machine to pump Slurry non ionic and electrolyte into the 8—Slurry non ionic and electrolyte tool steel line in, subsequently to the 9—Gravity feed collector line out and finally to the 10—Slurry non ionic and electrolyte tool steel reservoir. Slurry non ionic and electrolyte is defined here as specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 55 elements and/or Specification 56 alloys manufactured preform slurry non ionic or electrolyte mechanically refined and nanoparticle high wear-heat resistant parts. After the 10—Slurry non ionic and electrolyte tool steel reservoir is filled the operator can electronically disengage or manually remove the manual stop control release pull pin. The operator then closes the 9B—Tool steel control to prepare for the extrusion. The operator would proceed by rotating the 1—Hydraulic control wheel in a clockwise fashion contracting the 7—Slurry non ionic and electrolyte tool steel press plate and forcing the Slurry non ionic and electrolyte comprised of non ionic or electrolyte mechanically refined and nanoparticle slurry formula into the 17—Tool steel extrusion die cast design internal cavity. The specified amount of Slurry non ionic and electrolyte is compressed to preform slurry non ionic or electrolyte mechanically refined and nanoparticle specification pressure measured in millibars Mb until the specified Slurry non ionic and electrolyte required to fill the 17—Tool steel extrusion die cast design internal cavity has been reached. The 1—Hydraulic control wheel is then locked until the 17—Tool steel extrusion die cast design internal cavity has been removed. The 2—Electronic servo processor sends an electrical signal to the 3—Hydraulic pump of the 7—Slurry non ionic and electrolyte tool steel press plate position that is calibrated to the 1—Hydraulic control wheel. The 3—Hydraulic pump receives an electrical signal from the 2—Electronic servo processor of the 7—Slurry non ionic and electrolyte tool steel press plate position that is calibrated to the 1—Hydraulic control wheel. The 3—Hydraulic pump pumps fluids to the 4—Hydraulic pipe. The 4—Hydraulic pipe receives fluids from the 3—Hydraulic pump and conveys the fluids to the 5—Hydraulic actuator. The 5—Hydraulic actuator receives fluids from the 4—Hydraulic pipe and the force from the fluids is transferred through the actuator as vertical up-and-down movement to an affixed 6—Hydraulic arm. The 6—Hydraulic arm moves vertically up-and-down and forces the 7—Slurry non ionic and electrolyte tool steel press plate to expand and contract. The 7—Slurry non ionic and electrolyte tool steel press plate is forced by the 6—Hydraulic arm to expand and contract. The 8—Slurry non ionic and electrolyte tool steel line in receives Slurry non ionic and electrolyte from an external pump and conveys them to the 9A—Gravity feed tool steel collector. The 8—Slurry non ionic and electrolyte tool steel line in can be ionic process tool steel interface positive or negative electrode electronically charged for enhanced formulation. The 9A—Gravity feed tool steel collector receives Slurry non ionic and electrolyte from the 8—Slurry non ionic and electrolyte tool steel line in and conveys them to the 10—Slurry non ionic and electrolyte tool steel reservoir. The 10—Slurry non ionic and electrolyte tool steel reservoir receives Slurry non ionic and electrolyte from the 9A—Gravity feed tool steel collector line out. After the 10—Slurry non ionic and electrolyte tool steel reservoir is filled the 9B—Tool steel control is utilized to close the opening to prepare for the extrusion and may be provisionally locked and stopped at any position. The 11—Slurry non ionic and electrolyte reservoir regulated tool steel carbonaceous-polyamide waste filtration removes waste from the 10—Slurry non ionic and electrolyte tool steel reservoir while it is being filled with Slurry non ionic and electrolyte from common recovery distillation heated interface tool steel and thermometer gauge, ordinary atmospheric pressure, vacuum pump barometric pressure measured in millibars Mb, and fractional distillation all waste gases are processed to flu gas detoxification system. The 12—Slurry non ionic and electrolyte reservoir expanded. The 13—Slurry non ionic and electrolyte reservoir contracted. The 14—Slurry non ionic and electrolyte reservoir brass or tool steel aperture and 15—Tool steel extrusion die cast design brass or tool steel fitting connects directly and conveys Slurry non ionic and electrolyte to the 17—Tool steel extrusion die cast design internal cavity. The 18—Tool steel extrusion die cast design internal cavity regulator carbonaceous-polyamide waste filtration and 18B—Tool steel vacuum release control and portal works in unison with the press plate drawing expanding and contracting Slurry non ionic and electrolyte removing waste from the 17—Tool steel extrusion die cast design internal cavity while it is being filled with Slurry non ionic and electrolyte from common recovery distillation heated interface tool steel and thermometer gauge, ordinary atmospheric pressure, vacuum pump barometric pressure measured in millibars Mb, and fractional distillation all waste gases are processed to flu gas detoxification system. The 17—Tool steel extrusion die cast internal cavity is designed as a tool steel extrusion die cast mold for each highly pure naturally occurring carbon and allotropes of carbon filler and adhesive insulator part comprised of two master extrusion tool steel halves. This is accomplished by first utilizing engineering drafting and computer aided design with the most advanced tool steel part manufacture process and tool steel part machining techniques and/or by utilizing replacement ceramic molds specification 35 to supplement the development of extrusion die cast master design manufacture process with high purity tool steel die cast extrusion molds. highly pure naturally occurring carbon, hybrid allotropes of carbon, and alternate carbon nanofoam inductor ACNFI filler and adhesive insulator vacuum control of nitrogen, hydrogen, chlorine, ether, amino acid, or element dispersion brake pads, electronic brushes and parts require two master extrusions tool steel mold halves for each specification part. highly pure naturally occurring carbon, hybrid allotropes of carbon, and alternate carbon nanofoam inductor ACNFI filler and adhesive insulator parts precision casting molds requires a minimum two and a maximum of six master extrusion tool steel mold halves for each specification part. highly pure naturally occurring carbon, hybrid allotropes of carbon, and alternate carbon nanofoam inductor ACNFI filler and adhesive insulator parts precision casting molds are utilized to manufacture highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator 1.0 to 2.5 phase extrusions and two to six master highly pure naturally occurring carbon, hybrid allotropes of carbon, and alternate carbon nanofoam inductor ACNFI filler and adhesive insulator mold halves per specification part. The manufacture process of 1.0 to 2.5 phase extrusions and die cast design for highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator requires two to six master extrusion tool steel halves for each two to six reciprocal highly pure naturally occurring carbon, hybrid allotropes of carbon, and alternate carbon nanofoam inductor ACNFI filler and adhesive insulator master precision casting molds parts allowing two A and B highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator to be combined. The 0.5 phase extrusion equals two die cast mold halves both equal to or less than one half 0.5 phase extrusion molten pour. The utility patent application specification concrete control room and monitoring station manufacturing in a complete vacuum and may supply rich oxygen from capillary feeders at varying points to the specified highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator part molten fill A and B fills up to four pours. The highly pure naturally occurring carbon, ACNFI filler and adhesive insulator half shell or 0.5 phase extrusion are designed and utilized for state of the art manufacture process when combining highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator in combination of layered foundry fills, parts may be sprayed and dipped non conductive adhesives insulator films, and all waste gases are processed to flu gas detoxification system. The highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator is a layered greater than 0% to less than 100% alloy component A and greater than 0% to less than 100% alloy component B part that is created in combination of layered foundry fills by utilizing two to six master highly pure naturally occurring carbon, hybrid allotropes of carbon, and alternate carbon nanofoam inductor ACNFI filler and adhesive insulator parts precision casting molds per specification part by pouring molten fill as a layered alloying component highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator four molten metal or other fill pours equal to 1.0 to 2.5 phase extrusions. The highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator is a layered greater than 0% to less than 100% highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator A component part, and greater than 0% to less than 100% highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator B component part created in combination of layered fills of two to six master highly pure naturally occurring carbon, hybrid allotropes of carbon, and alternate carbon nanofoam inductor ACNFI filler and adhesive insulator extrusion die cast mold halves equal to 1.0 to 2.5 phase extrusions. Distillation reservoir and recovery basin made of super alloy, and/or ceramic, and/or allotropes of carbon or alternate carbon nanofoam inductor ACNFI filler and adhesive insulator including variable hydraulic press plate for specification distillation processing. Polarized windshields, optical glass, polymers gels distillation positively and negatively charging electrolysis of molten glass, optical glass, reflective beads, polymer gels, lenses, mirrors, polarized windshield casted or molten diffusion forged, and molten specification materials 1.0 to 2.0 phase casted or extruded and distillation processing of specification highly pure metal, super alloy, ceramic, and alkaline. Windshield and specification materials are chemically surface treated distillation processed with specification acid and bases and Specification 55 elements or mechanically refined and nanoparticle specification acid and bases dispersions. Electrolysis electroplating of mechanically refined and nanoparticle Specification 55 elements, Specification 56 alloys, nanoparticle alumina, allotropes of carbon, alternate carbon nanofoam inductor ACNFI series and parallel circuits. Electrolysis distillation positively and negatively charged electron molecules allotropes of carbon, alternate carbon nanofoam inductor ACNFI, nanoparticle alumina, Specification 55 elements, and Specification 56 alloys with greater and lesser than normal atmospheric pressure, super heating, super cooling scientific molecular diffusion, and fractional distillation are accomplished. Distillation processing mechanically refined particles measure in microns Symbol μ lower-case letter mu metric SI equivalent silica mineral, mineral sands, heavy minerals, alumina, nanoparticle alumina, highly pure naturally occurring carbon, alkaline, acid solids, allotropes of carbon, alternate carbon nanofoam inductor ACNFI, gold, platinum, lead, acrylic and synthetic polymers catalyst gaseous and electrolysis process material for sintering and smelting pouring molten materials to apertures of variable hydraulic press plate, die cast extrusion molds, crucibles, and mold casings. Other distillation processing mechanically refined and nanoparticle preform slurry non ionic or electrolyte dispersion or molten highly pure metal, super alloy, highly pure naturally occurring carbon, allotropes of carbon, alternate carbon nanofoam inductor ACNFI, nanoparticle alumina, alumina, silica alumina or molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, silica mineral, mineral sands, heavy minerals, glass, acrylic, synthetic polymer, acid solid, impedance matching ceramic red brick insulator, molybdenum, ceramic zirconia, ceramic silica, ceramic clay, calcium carbonate CaCO₃, silicon dioxide SiO₂, sodium oxide Na₂O, calcium oxide CaO, alkaline, minerals, including ionic suspension elements and ceramic silica mineral insulator for Specification 55 elements highly pure metal, and Specification 56 alloys. Distillation reservoir specification manufactured battery conservation of energy cool and cold low temperature operating range made Series of right angles 2π radians or one full turn the sum of the exterior angles form convex regular polygons corrugated and compartmented architecture techniques monocombe shapes of triangle square pentagon hexagon heptagon octagon and nonagon and right angle combinations light makeweight design electromagnetic conductive Liquid and gaseous suspension elements of group 17 the halogens, highly pure ammonia Nh3, antimony Sb, methane Ch4, hydrogen allotropes of carbon HC hydrocarbons compound and Specification 55 elements electromagnetic conductive Liquid and gaseous suspension mechanically refined particles measure in microns Symbol μ lower-case letter mu metric SI equivalent alumina particles, alkaline particles, nickel particles, cadmium particles, lithium particles, magnesium particles, lead particles, fused ionic material complex mechanically refined particles measure in microns Symbol μ lower-case letter mu metric SI equivalent acid complex particles, alkaline complex particles, antimonide complex particles, halide complex particles, alkalide complex particles, mechanically refined particles measure in microns Symbol μ lower-case letter mu metric SI equivalent Specification 55 conductive elements and Specification 56 conductive alloys, allotropes of carbon, alternate carbon nanofoam inductor ACNFI, and nanoparticle alumina measure in nanometers Nm. Distillation processing and/or for up to four molten pours 1.0 to 1.0 to 2.5 phase casted or extruded or preform slurry non ionic or electrolyte. Molten pours and variable hydraulic press plate preform slurry non ionic or electrolyte mechanically refined and nanoparticle dispersion under vacuum control room scientific distillation ordinary atmospheric pressure less than ordinary atmospheric pressure catalyst gases other Specification 55 elements argon, carbon monoxide, carbon dioxide, or other gases mechanically refined or nanoparticle suspension catalyst greater or lesser than ordinary atmospheric pressure molecular diffusion, super cooling, and fractional distillation specification suspension may also accomplish allotropes of carbon hybridizations. Super alloy super cooling refrigeration vacuum pump and super alloy curved or linear expression comprising a scientific aperture, a divergence measured in angulation, and a scientific aperture diffusive gaseous particle vacuum pump negative pressurized stream accelerator super cooling refrigeration deceleration with or without nanoparticle synthesizing laser ablation and multi-waveform ablation X, Y, Z alignment with or without fluxing agents, nanoparticle alumina al13, and fractional vacuum distillation gaseous and/or positive and negative ionic charges recovery and super alloy and/or ceramics and/or highly pure naturally occurring carbon and allotropes of carbon filler and adhesive insulator distillation reservoir variable hydraulic press plate expanded and contracted greater or lesser than ordinary atmospheric pressure distillation recovery fractional vacuum distillation gaseous and/or positive distillation and variable hydraulic press plate expanded and contracted greater or lesser than ordinary atmospheric pressure distillation recovery allotropes of 6C carbon, carbon, solid, liquid, and gases chemical non ionic groups of amphoteric polysaccharide linear or branched alkyl compounds or electrolytes and/or liquid ions and/or ionic melts and/or fused and/or acid and bases catalyst and/or catalyst slurry reservoir 6C allotropes of carbon and liquid and/or liquid vapors and/or gaseous electrolyte catalyst acids and solid materials highly pure metal, super alloy, highly pure naturally occurring carbon, allotropes of carbon, alternate carbon nanofoam inductor ACNFI, nanoparticle alumina, alumina, silica alumina or molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, silica mineral, mineral sands, heavy minerals, glass, acrylic, synthetic polymer, acid solid, impedance matching ceramic red brick insulator, molybdenum, ceramic zirconia, ceramic silica, ceramic clay, calcium carbonate CaCO₃, silicon dioxide SiO₂, sodium oxide Na₂O, calcium oxide CaO, alkaline, minerals, including ionic suspension elements and ceramic silica mineral insulator for Specification 55 elements highly pure metal, and Specification 56 alloys for building materials Number 1. preform slurry specification formula non ionic or electrolyte acid, base, or alkyl distillation reservoir specification vacuum processing scientific electrolysis covalent bonding sequence drawing and spinning formula solutions mechanically refined and nanoparticle dispersion fine concrete, mortar, brick, and tiles, and high wear-heat resistant parts brushes, windings, coils, battery cells, electronic resistors, capacitors, brake pads, washers, spacers, bushings, annealing, drawn, spun, coils, windings, wire, woven textile mesh, shielding, and 1.0 to 2.5 phase casted or extruded die cast molding. An insulate, electronic part, brake calipers part, rotors part, brake pads, washers, spacers, shims, dowels, bushings part light weight chemical ionic acid usually an amino acid, non ionic bases usually nitrogen/hydrogen or non ionic groups of amphoteric polysaccharide linear or branched alkyl compounds usually methyl continuous sheets cut films insulate, specification formula non ionic or electrolyte acid, base, or alkyl distillation reservoir specification vacuum processing scientific electrolysis covalent bonding sequence drawing and spinning formula solutions mechanically refined and nanoparticle dispersion continuous spinning yarn and thread, preform optical grade silica, forged optical grade silica line cable, preform optical grade natural polymer or synthetic polymer silica, forged optical grade polyamide silica line cable, variable hydraulic press, plate or distillation reservoir liquid dispersion and particulate matter PM specifications of nanoparticle and condensation-nuclei type size particles measure in microns Symbol μ lower-case letter mu metric SI equivalent natural polymer carbon, natural polymer or synthetic polymer carbon, allotropes of carbon, silica, allotropes of carbon silica and alumina/nano alumina silica allotropes of carbon slurry non ionic heated or chilled interface 8—Slurry non ionic tool steel line in heated or chilled chemical ionic acid usually an amino acid, non ionic bases usually nitrogen/hydrogen or non ionic groups of amphoteric polysaccharide linear or branched alkyl compounds usually methyl liquid dispersion liquid dispersion heated chemical non ionic groups of amphoteric polysaccharide linear or branched alkyl compounds methyl liquid dispersion natural polymer carbon, natural polymer or synthetic polymer carbon, allotropes of carbon, allotropes of carbon silica, allotropes of carbon silica alumina/nano alumina and allotropes of carbon alumina/nano alumina or liquid dispersion chilled polysaccharide linear or branched alkyl compounds and reinforcement of allotropes of carbon networks in suspension drying over usually fifteen minutes result network light weight natural polymer carbon, natural polymer or synthetic polymer carbon, allotropes of carbon, allotropes of carbon silica, allotropes of carbon silica alumina/nano alumina and allotropes of carbon alumina/nano alumina controllable, high purity, connectivity, strength, conductivity, and/or shape. Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 55 Elements spectrum. Formula enhanced molten diffusion mechanically shattered chards and refined particulate matter PM Sio² gaseous suspension are drawn into heated 2200° C. molten diffusion C-6 allotropes of carbon reservoir flash forming carbonaceous-silica Si+C6 allotropes of carbon is SiC silica allotropes of C6 carbon or Sio²+2C6 (s) is SiC6 (s)+2O (g) thus allotropes of carbon Silicon-C6 is formed, formula enhanced molten diffusion mechanically shattered chards, refined or nanoparticle particulate matter PM Sio² and al13 gaseous suspension are drawn into heated 2200° C. molten diffusion C-6 allotropes of carbon reservoir flash forming carbonaceous-alumina silica Si+al13+C6 allotropes of carbon al13 alumina is Sial13C silica allotropes of carbon al13 alumina or Sio²+al13+2C6 (s) is SiC6al13 (s)+2O (g) thus allotropes of carbon alumina Silicon-C6al13 is formed. Vacuum or compression variable hydraulic press plate and pump specification gaseous negative or positive pressure in atmospheres mechanically refined and nanoparticle molecules, vacuum gaseous distillation reservoir mechanically refined and nanoparticle molecule transfer and mixing compounds, and vacuum gaseous mechanically refined and nanoparticle molecule preparation for control room casting, molding, sintering, and smeltering. Additional distillation reservoir dioxide CO₂ and carbon monoxide CO gaseous super alloy super cooling refrigeration molten diffusion particulate matter PM quenching by vacuum pump and super alloy curved or linear expression comprising a scientific aperture, a divergence measured in angulation, and a scientific aperture diffusive gaseous particle vacuum pump negative pressurized stream accelerator super cooling refrigeration deceleration and distillation reservoir supercooled quenching variable hydraulic press plate less than normal atmospheric with or without negatively pressurized distillation reservoir gaseous molecular diffusion and super alloy heated interface tool steel or supercooled temperature deceleration carbon dioxide CO₂ and carbon monoxide CO fractional distillation hybridizations that may releasing oxides of O₂ and O₁. Distillation reservoir with or without Multi waveform laser X, Y, Z field alignment carbon dioxide CO₂ and carbon monoxide CO ablation and fractional distillation synthesizing. Distillation processing particulate matter PM with or without Carbon dioxide CO₂ and Carbon Monoxide CO are vacuum pump distillation reservoir negatively charged—allotropes of carbon electron molecule electrolysis processed and reinforced with extenders and fillers negatively charged—allotropes of alternate carbon nanotube inductor ACNTI particles. The distillation reservoir may contain of a gaseous mixture consisting of carbon dioxide CO₂, carbon monoxide CO, oxides O₂, oxides O₁, and negatively charged—allotropes of alternate carbon nanotube inductor ACNTI particles. Specification of particulate matter PM carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent, carbonaceous-polyamide, crystalline silica optical, crystalline silica synthetic polymer optical, crystalline silica cellulosic natural polymer, and crystalline silica cellulosic rubber natural polymer optical filtered and non filtered specifications negative charging chemical electron molecule electrolysis drawing and spinning, solution Liquid or gaseous quenching, vacuum processing evaporation and carbonaceous-polyamide, crystalline silica optical, crystalline silica synthetic polymer optical, crystalline silica cellulosic natural polymer, and crystalline silica cellulosic rubber natural polymer optical filtered and non filtered specifications high molecular-weight carbonaceous particulate matter PM in condensation-nuclei type size particles measure in microns Symbol μ lower-case letter mu metric SI equivalent fine beads are collected and vacuum packed sealed for secondary phase Function-specific optical properties manufacturing, and carbonaceous-polyamide beads vacuum packed sealed for fiberaceous filament yarn and thread Function-specific properties manufacturing. Universal pulp agro-fiberaceous cellulosic filaments and subsequent fatty acids and oils extractions cellulosic natural polymer using common distillation processing techniques. The primary agro-fiberaceous filaments sought come from agro-fiberaceous waste materials hulls, husks, pits, straw, and peels. The end resultant filament is assorted lipid, lignin, liber, linnet and viscose. Characteristics and carbonaceous products of these woody plants are extracting cellulosic filaments for specification formula non ionic or electrolyte acid, base, or alkyl distillation reservoir specification vacuum processing scientific electrolysis covalent bonding sequence drawing and spinning formula solutions mechanically refined and nanoparticle dispersion continuous spinning yarn and thread and subsequent textile manufacturing. The process begins with collecting and pulverizing-shredding in specification mesh sizes massive tonnage of agro-fiberaceous waste materials hulls, husks, pits, straw, and peels. The massive tonnage is batch processed exposure to steam begins cellulosic extractions and convections under ordinary atmospheric pressure, quenching, evaporation, condensing, solution purifying electrolysis particle separations, and chemical pH probe. From here due the complexity of the blend agro-fiberaceous materials follows a simple sequence in order of distillation techniques with varying applications of aging oxidation agents, solution oxidations, solution and vacuum pumping extraction, centrifuge and electrolysis spinning separation, electron molecule positive and negative electrolysis preparations, steam extractions, pH probe, solution spinning and drawing electrolysis, cooling, chopping continuous filament yarn immersion pressing, aging reagents, pH probe, dissolving, filtering, ripening, simple alloy or steel simple acid chemical extrusion, electrolysis solution spinning drawing and spinning filaments, wet process and gaseous purification, bleaching with chloride, ultra-violet UV lamps, or Sunlight, dying with pigments, filament yarn washing, cutting, drying, specialized vacuum packing and storage. Number 2. Building Materials preform slurry specification formula non ionic or electrolyte acid, base, or alkyl distillation reservoir specification vacuum processing scientific electrolysis covalent bonding sequence drawing and spinning formula solutions mechanically refined and nanoparticle dispersion fine concrete, mortar, brick, and tiles. Building materials preform modular fine concrete arrives in trucks readymade utilized with manufacture process connector system die cast super alloy or tool steel molten-forged crimping tool heated or cooled particulate matter carbonaceous-polyamide interwoven textile mesh, and molten-forged super alloy or tool steel connectors that work with easy to build box framing techniques, hydraulic cement on-site preform modular casting molds and preform modular fine readymade concrete poured directly from hydraulic and vacuum pumps on readymade truck. Preform modular manufacture process connector system surveying tools and techniques ionic paint markers and alidade Very high frequency VHF and Ultra high frequency UHF industrial/business narrowband 12.5 kHz bandwidth efficiency technology utilizing crystal quartz transceiver transmitting and receiving to crystal quartz transceiver ground mode-C marker Earth Positioning System EPS transmitting and receiving mode-C for construction generator wavenumber data added and subtracted order identification in nanoseconds processing geodetic spatial datum reference Universal Transverse Mercator UTM geographic six-ten digit grid coordinates, distance, azimuth, and level reference identification Cartesian system datum numeric generation returns coordinates in a local east-north-up ENU Cartesian system corresponding to coordinates X, Y, Z in an Earth-Centered Earth-Fixed ECEF spheroid-centric Cartesian system. Ready mix mortar is packaged and distributed in specially made thermoplastic sealed injection molded preformed containers and airtight dispenser system. Ready mix mortar is packaged and distributed in specially made thermoplastic sealed injection molded preformed containers and airtight dispenser system. Number 3. Specialized construction abatement and miners suit carbonaceous-polyamide textile interwoven mesh push to talk PTT and self-actuating microphone intercommunication system, textile woven carbonaceous-polyamide, carbonaceous fiberaceous, and composite materials, knitted/stitched textile fabrics, and woven-mesh in X, Y, and Z alignment carbonaceous-polyamide, carbonaceous fiberaceous, and composite materials, knitted/stitched textile fabrics, and woven-mesh in X, Y, and Z alignment rip-stop reinforcing technique weaving thick reinforcement threads interwoven at regular intervals in a crosshatch pattern fabrics having thin and light makeweight structure from thick threads being interwoven in a thinner cloth reinforcing technique weaving thick reinforcement threads interwoven at regular intervals in a crosshatch pattern fabrics having thin and light makeweight structure from thick threads being interwoven in a thinner cloth fibers, liners, air tight light makeweight head gear, crystalline silica optical and crystalline silica optical natural polymer carbon, natural polymer or synthetic polymer carbon filtered and non filtered visor, inner layer air pressurized isolated breathable oxygen gaseous mixture supplied by light makeweight textile woven carbonaceous-polyamide, carbonaceous fiberaceous, and composite materials, knitted/stitched textile fabrics, and woven-mesh in X, Y, and Z alignment rip-stop reinforcing technique weaving thick reinforcement threads interwoven at regular intervals in a crosshatch pattern fabrics having thin and light makeweight structure from thick threads being interwoven in a thinner cloth sewn fibers oxygen tank and second dormant layer carbon dioxide CO₂ accelerated supercooled system powered by magnesium nanoparticle light makeweight battery cell. Number 4. Supplemental super alloy super cooling refrigeration vacuum pump and super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant super cooling super alloy or super alloy. Refrigerant specification of naturally occurring carbon dioxide CO₂ and distillation reservoir specification hybridizations of allotropes of carbon, solution pure oxides O₂, distillation reservoir covalent bonding, electrolysis, and molecular diffusion produce hybrid allotropes of carbon and molecular dioxide CO₂ compound, silica hybrid allotropes of carbon molecular dioxide SiCO₂ compound, chloride hybrid allotropes of carbon CCl compound, methane Ch4, nitrate hybrid allotropes of carbon NC compound, and hydrogen hybrid allotropes of carbon HC compound. High negative pressurized levels are maintained by vacuum pump circuit. Self contained naturally occurring carbon dioxide CO₂, hybrid allotropes of carbon and molecular dioxide CO₂ compound, methane Ch4, nitrate hybrid allotropes of carbon NC compound, and hydrogen hybrid allotropes of carbon HC compound refrigeration units commercial, residential, or portable super alloy vacuum pump drawing gaseous refrigerant through Insulated super alloy feeder tubes in a parallel circuit to separate super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant is then passed over super alloy and through cooling fan. High negative pressurized levels are maintained by vacuum pump circuit. Self contained naturally occurring carbon dioxide CO₂, hybrid allotropes of carbon and molecular dioxide CO₂ compound, methane Ch4, nitrate hybrid allotropes of carbon NC compound, and hydrogen hybrid allotropes of carbon HC compound refrigeration units commercial, residential, or portable super alloy vacuum pump rated alternating current AC or direct current DC drawing gaseous refrigerant through insulated super alloy feeder tubes in a parallel circuit to separate numeric super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to less than −109 degrees Fahrenheit or −78.5 degrees Celsius supercooled gaseous refrigerant passes over super alloy and through cooling fan. Numeric isolated super alloy cylinders in series and parallel thermo conductive circuits are connected to the refrigeration unit from super alloy connecting rods super cooling the outside walls of the cylinders. The outer cylinder cools activating an electronic air compressor rated alternating current AC or direct current DC filling the inner variable cylinders with compressed air providing diffusive compensation expanding the inner cylinders forcing the carbon dioxide CO₂ filled outer cylinders through a continuous circuit of super alloy curved or linear expression comprising a scientific aperture, a divergence measured in angulation, and a scientific aperture diffusion gaseous refrigerant particle vacuum pump negative pressurized stream accelerator super cooling refrigeration deceleration temperature to greater than −109 degrees Fahrenheit or −78.5 degrees Celsius carbon dioxide CO₂ forming dry ice in the outer internal press plate mold and Super alloy, and/or ceramic, and allotropes of carbon, and alternate carbon cylinders. High negative pressurized levels are maintained by vacuum pump circuit. Number 5. Distillation and recovery basin automation mass production variable hydraulic press plate mold and Super alloy, and/or ceramic, and allotropes of carbon, and alternate carbon nanofoam inductor ACNFI filler and adhesive insulator pour aperture located in the center and hydraulic cylinder located on the right expanded and contracted for molten pouring highly pure metal printed circuits, super alloy including allotropes of carbon printed circuits nickel, cadmium, lithium, lead, antimonide, halide, alkalide, Specification 55 elements printed circuits, or Specification 56 alloys printed circuits and/or ceramic insulator for 1.0, and 2.0 phase extrusion plates, sheets, foil, and leaf central processing unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica allotropes of carbon insulator. Distillation and recovery basin automation mass production crucible casted molten highly pure metal printed circuits, super alloy, allotropes of carbon printed circuits nickel, cadmium, lithium, lead, antimonide, halide, alkalide, Specification 55 elements printed circuits, or Specification 56 alloys printed circuits and/or ceramic insulator for 1.0, and 2.0 phase castings plates, sheets, foil, and leaf central processing Unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica allotropes of carbon insulator. Distillation and recovery basin automation mass production variable hydraulic press plate mold and Super alloy, and/or ceramic, and allotropes of carbon, and alternate carbon nanofoam inductor ACNFI filler and adhesive insulator pour aperture located in the center and hydraulic cylinder located on the right expanded and contracted for pouring non ionic or electrolyte preform slurry with mechanically refined and nanoparticle dispersion fine printing highly pure metal printed circuits, allotropes of carbon, alumina nanoparticles, copper nanoparticles, colloidal gold, silver nanoparticles, iron nanoparticles, element nanoparticles and platinum nanoparticles printed circuits, super alloy including allotropes of carbon printed circuits, allotropes of carbon printed circuits, alternate carbon nanofoam inductor ACNFI printed circuits, allotropes of carbon ionic suspension element printed circuits nickel, cadmium, lithium, magnesium, lead, antimonide, Specification 55 elements printed circuits, or Specification 56 alloys printed circuits and/or ceramic insulator for 1.0, and 2.0 phase extrusion plates, sheets, foil, and leaf central processing unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica allotropes of carbon insulator. Distillation and recovery basin automation mass production crucible casted non ionic or electrolyte preform slurry with mechanically refined or nanoparticle dispersion fine printing highly pure metal printed circuits, allotropes of carbon, alumina nanoparticles, copper nanoparticles, colloidal gold, silver nanoparticles, iron nanoparticles, element nanoparticles and platinum nanoparticles printed circuits, super alloy including allotropes of carbon printed circuits, allotropes of carbon printed circuits, alternate carbon nanofoam inductor ACNFI printed circuits, allotropes of carbon ionic suspension element printed circuits nickel, cadmium, lithium, magnesium, lead, antimonide, Specification 55 elements printed circuits, or Specification 56 Alloys printed circuits and/or ceramic for 1.0, and 2.0 phase castings plates, sheets, foil, and leaf central processing Unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica allotropes of carbon insulator. Distillation reservoir interchangeable combinations of preform slurry non ionic, electrolyte, or molten ceramic and conductive circuits 2.0 extrusions or castings are accomplished for each specification part. Alternate carbon nanofoam inductor ACNFI electronic storage media is manufactured plates, sheets, foil, or leaf on ceramic, highly pure metal, super alloy, or distillation reservoir alternate carbon nanofoam inductor ACNFI annealing, drawing, and spun pressed electronic tape 3250 bits per second BPS, 6250 bits per second BPS, 7 MM millimeter, and compact disc CD writable random access memory WRAM. Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 55 Elements spectrum. Number 6. Specification of molten diffusion particulate matter PM melts carbonaceous-polyamide, crystalline silica optical, crystalline silica synthetic polymer optical, crystalline silica cellulosic natural polymer, and crystalline silica cellulosic rubber natural polymer optical filtered and non filtered specifications condensation-nuclei type size particles measure in microns Symbol μ lower-case letter mu metric SI equivalent crystalline silica optical, crystalline silica synthetic polymer optical, crystalline silica cellulosic natural polymer, and crystalline silica cellulosic rubber natural polymer optical added molten diffusive particulate matter PM filtered condensation-nuclei type size particles measure in microns Symbol μ lower-case letter mu metric SI equivalent filtered versions of crystalline silica optical, crystalline silica synthetic polymer optical, crystalline silica cellulosic natural polymer, and crystalline silica cellulosic rubber natural polymer optical are filtered alumina, filtered nano alumina, filtered naturally occurring carbon, filtered allotropes of—alternate carbon nanotube inductor and infrared spectrum light analogous identification, filtered radioactive radiation protection precious metals, and filtered Specification 55 Elements spectrum. Number 7. Manufacture process of 1.0 to 2.5 phase extrusions die cast molding for precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated, polarized casted and molten diffusion forged reflective beads radiate outwards up to and greater than 400 percent magnification for aircraft and airway systems, and allotropes of carbon, or alternate carbon nanofoam inductor ACNFI filler and adhesive insulator. The precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated, polarized casted and molten diffusion forged reflective beads radiate outwards up to and greater than 400 percent magnification for aircraft and airway systems, and allotropes of carbon, or alternate carbon nanofoam inductor ACNFI filler and adhesive insulator is a layered greater than 0% to less than 100% precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated, polarized casted and molten diffusion forged reflective beads radiate outwards up to and greater than 400 percent magnification for aircraft and airway systems, and allotropes of carbon, or alternate carbon nanofoam inductor ACNFI filler and adhesive insulator and greater than 0% to less than 100% other precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated, polarized casted and molten diffusion forged reflective beads radiate outwards up to and greater than 400 percent magnification for aircraft and airway systems, and allotropes of carbon, or alternate carbon nanofoam inductor ACNFI filler and adhesive insulator part that is created by pouring molten metal, alloy, halide, alkalide, antimonide, ceramic, glass, acid solid, alkaline, synthetic polymer, non molten formula ceramic slip, acid solid, alkaline, and preform slurry non ionic or electrolyte allotropes of carbon, or alternate carbon nanofoam inductor ACNFI filler and adhesive insulator into a cast mold over a process of 1.0 to 2.5 phase extrusions that create two to six molded casts for each designed master tool steel part that is manually machined and manufactured named part X external layer highly pure metal, super alloy, halide, alkalide, antimonide, ceramic, glass, acid solid, alkaline, synthetic polymer, including preform slurry non ionic or electrolyte allotropes of carbon, or alternate carbon nanofoam inductor ACNFI filler and adhesive insulator and Part Z the internal layer other highly pure metal, super alloy, halide, alkalide, antimonide, ceramic, glass, synthetic polymer, acid solid, alkaline, including preform slurry non ionic or electrolyte allotropes of carbon, or alternate carbon nanofoam inductor ACNFI filler and adhesive insulator. Manufactured process of 1.0 to 2.5 phase extrusions die cast molding for precision casting of super alloy, ceramic, and material ultimately create a single part identical to the master designed and machine manufactured part with the exception to the chemical element is now a super alloy, super alloy ceramic, or super material that may be layered greater than 0% to less than 100% highly pure metal, super alloy, super material, including allotropes of carbon, or alternate carbon nanofoam inductor ACNFI filler and adhesive insulator and greater than 0% to less than 100% other highly pure metal, super alloy, super material including allotropes of carbon, and alternate carbon nanofoam inductor ACNFI filler and adhesive insulator. Processing molded halves sequence 1 to 9 of manufacture process 1.0 to 2.5 phase extrusions die cast molding for precision casting of highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields and optical No₃-diamond dust mineralization transceiver alignment integrated, polarized casted and molten diffusion forged reflective beads radiate outwards up to and greater than 400 percent magnification for aircraft and airway systems, and allotropes of carbon, or alternate carbon nanofoam inductor ACNFI filler and adhesive insulator part X and part Z side profile not shown here of casting for part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 filled with molten on non molten formula materials including preform slurry non ionic or electrolyte allotropes of carbon, or alternate carbon nanofoam inductor ACNFI filler and adhesive insulator sequence 9. The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace. The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry. The external tolerances of all of the four cast covers X and Z are identical opposing so that X and Z halves can be joined and prepared for two separate halves molten or non molten formula highly pure metal, super alloy, or material including allotropes of carbon, or alternate carbon nanofoam inductor ACNFI filler and adhesive insulator fills. After the poured molten highly pure metal, super alloy, or materials including allotropes of carbon, or alternate carbon nanofoam inductor ACNFI filler and adhesive insulator cools or cures then both extruded halves are removed and stored. The remainder halves with highly pure metal, super alloy, or materials including allotropes of carbon, or alternate carbon nanofoam inductor ACNFI filler and adhesive insulator are then joined and prepared for a second molten fill of greater than 0% to less than 100% highly pure metal, super alloy, or materials including allotropes of carbon, or alternate carbon nanofoam inductor ACNFI filler and adhesive insulator. After the fill is cooled the whole part is removed from the cast halves and may be inspected, deburred, and/or finished. Number 8. Utility patent application specification concrete control room and monitoring station manufacturing in a complete vacuum and may supply rich oxygen from capillary feeders at varying points to utility patent application specification for with die cast mold extrusion or printing hot smelters casting manufacturing of specified highly pure metal, super alloy, halide, alkalide, antimonide, ceramic, acid solid, alkaline, integrated or polarized molten diffusion forged crystalline silica optical and crystalline silica optical natural polymer carbon, natural polymer or synthetic polymer carbon filtered and non filtered beads, gels, cables, lenses, glasses, mirrors, visors, panels, and windshields, spectra No₃-diamond dust mineralization transceiver integrated or polarized beads, and allotropes of carbon, or alternate carbon nanofoam inductor ACNFI filler and adhesive insulator including two to six master extrusion halves 1.0 to 2.5 phase extrusions per specification part molten foundry fill up to four pours and the manufacture process or assembly for each specification component or part thereof and all waste gases are processed to flu gas detoxification system. Number 9. Utility patent application specification concrete control room and monitoring station manufacturing in a complete vacuum and may supply rich oxygen from capillary feeders at varying points to utility patent application specification manufacturing of highly pure metal, super alloy, carbon, ceramics, acid solid, alkaline, glass, acrylic, synthetic polymer, halide, alkalide, nonconductive zirconia, allotropes of carbon, alternate carbon nanofoam inductor ACNFI, and impedance matching load or signal ceramic red brick clay insulator hot pouring casting printing with molten foundry fill of die cast mold precision casting of bars, rods, plates, sheets, foil, leaf, alumina, copper, wire, annealing, drawing, and spun coils and windings for electronic component, highly pure metal, super alloy drawing, annealing, and spinning process for wire, spun cable, interwoven rebar mesh with or without interwoven textile mesh heated or supercooled particulate matter synthetic and polymer resins carbonaceous-polyamide unit of measurement in gage manufacture process connector system super alloy die cast tool steel molten-forged crimping tool that works with molten-forged mesh connectors. Other construction tools include powders nitrate hardened nitride steel grit unit of measurement in mesh or grit size. Number 10. Utility patent application specification concrete control room and monitoring station manufacturing in a complete vacuum and may supply rich oxygen from capillary feeders at varying points to utility patent application specification 1.0 to 2.5 phase extrusions manufacturing of highly pure metal or super alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system. Number 11. Utility patent application specification concrete control room and monitoring station manufacturing in a complete vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath hydrochloric acid, ammonia from nitrogen, and hydrogen anticorrosive purification treatment and all waste gases are processed to flu gas detoxification system. Number 12. Utility patent application specification concrete control room and monitoring station manufacturing in a complete vacuum and may supply rich oxygen from capillary feeders at varying points to mechanically refined metal ore sintered and smeltered non metallic additive allotropes of carbon alloyed super alloy, steel super carbon steel, tungsten super carbon tungsten, or additive sintered and smeltered molybdenum for homogenization steel molybdenum steel, or tungsten molybdenum tungsten and all waste gases are processed to flu gas detoxification system. Number 13. Utility patent application specification manufacturing of highly pure metal, super alloy, carbon, ceramics, acid solid, alkaline, glass, acrylic, synthetic polymer, halide, alkalide, nonconductive zirconia, allotropes of carbon, alternate carbon nanofoam inductor ACNFI, and impedance matching load or signal ceramic red brick clay insulator 1.0 to 2.5 phase extrusions or half shell casted composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, super alloy, acid solid, alkaline, glass, acrylic, synthetic polymer, halide, alkalide, nonconductive zirconia, impedance matching load or signal ceramic red brick clay insulator, allotropes of carbon, or alternate carbon nanofoam inductor ACNFI six sides rectangle, or square, or three sides continuous rod or cylinder highly pure metal, super alloy, acid solid, alkaline, glass, acrylic, synthetic polymer, halide, alkalide, non conductive zirconia, impedance matching load or signal ceramic red brick clay insulator, allotropes of carbon, or alternate carbon nanofoam inductor ACNFI, or three sides zircon, nitrate zircon, and nitrate silica with or without molecular reinforcements nanoparticle alumina and allotropes of carbon cutting tools, or two sides continuous for drill bits half shell casted tools measured in gage. Number 14. Utility patent application specification concrete control room and monitoring station manufacturing in a complete vacuum and may supply rich oxygen from capillary feeders at varying points to utility patent application specification manufacturing of highly pure metal, super alloy, carbon, ceramics, acid solid, alkaline, glass, acrylic, synthetic polymer, halide, alkalide, nonconductive zirconia, allotropes of carbon, alternate carbon nanofoam inductor ACNFI, and impedance matching load or signal ceramic red brick clay insulator hot pouring casting printing with molten foundry fill of die cast mold precision casting of bars, rods, plates, sheets, foil, leaf, alumina, copper, wire, annealing, drawing, and spun coils and windings for electronic component, highly pure metal, super alloy drawing, annealing, and spinning process for wire, spun cable, interwoven rebar mesh with or without interwoven textile mesh heated or supercooled particulate matter synthetic and polymer resins carbonaceous-polyamide unit of measurement in gage manufacture process connector system super alloy die cast tool steel molten-forged crimping tool that works with molten-forged mesh connectors. Other construction tools include powders nitrate hardened nitride steel grit unit of measurement in mesh or grit size. Utility patent application specification manufacture process of replacement ceramic precision casting molds specification 35 for with manufacturing highly pure metal, super alloy, acid solid, alkaline, glass, acrylic, synthetic polymer, halide, alkalide, nonconductive zirconia, impedance matching load or signal ceramic red brick clay insulator, allotropes of carbon, or alternate carbon nanofoam inductor ACNFI.

3. Electronic parts Number 15. Utility patent application specification manufacture process of preform slurry non ionic or electrolyte mechanically refined and nanoparticle dispersion allotropes of carbon with or without ionic suspension element Specification 55 elements or Specification 56 alloys extrusion or casted highly pure metal, super alloy, allotropes of carbon with or without ionic suspension element Specification 55 elements, Specification 56 alloys, and alkaline, halide, antimonide, or alkalide, nonconductive zirconia, and impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink series and parallel circuits two positive and negative terminal poles commonly copper alloy measured in Volts, or of preform slurry non ionic or electrolyte alternate carbon nanofoam inductor ACNFI extrusion, or casted highly pure metal, super alloy, alternate carbon nanofoam inductor ACNFI, nonconductive zirconia, and impedance matching load or signal ceramic red brick clay insulator electronic part equivalent to one resistor, switch, relay, or electronic part inductor, antinode coupler, and ground series and parallel circuits two negative terminal poles commonly copper alloy measure in Ohms of inductor, antinode coupler, and ground or two positive and negative terminal poles commonly copper alloy measured in Volts. All electronic parts two sides casted conductive plate, sheet, foil, or leaf highly pure metal, super alloy, halide, antimonide, or alkalide rectangle, square, continuous rod or cylinder. Rectangle or square six sides, five sides nonconductive zirconia, impedance matching load or signal ceramic red brick clay insulator, allotropes of carbon, or alternate carbon nanofoam inductor ACNFI, plate, sheet, foil, or leaf casted insulated, and one side layered or non layered conductive highly pure metal, super alloy, and/or alkaline, halide, antimonide, or alkalide, plate, sheet, foil, or leaf casted conductive, or four sides nonconductive zirconia, impedance matching load or signal ceramic red brick clay insulator, allotropes of carbon, or alternate carbon nanofoam inductor ACNFI casted plate, sheet, foil, or leaf insulated, and two conductive highly pure metal, super alloy, and/or alkaline, halide, antimonide, or alkalide, plate, sheet, foil, or leaf casted series and parallel circuits and two positive and negative terminal poles commonly copper alloy measured in Volts or two negative terminal poles commonly copper alloy measured in Ohms to antinode coupler, or continuous rod or cylinder three sides, one continuous side nonconductive zirconia, impedance matching load or signal ceramic red brick clay insulator, allotropes of carbon, or alternate carbon nanofoam inductor ACNFI, plate, sheet, foil, or leaf casted insulated, and two sides conductive highly pure metal, super alloy, and/or alkaline, halide, antimonide, or alkalide, plate, sheet, foil, or leaf casted series and parallel circuits and two positive and negative terminal poles commonly copper alloy measured in Volts or two negative terminal poles commonly copper alloy measured in Ohms to antinode coupler preform slurry non ionic or electrolyte casted ionic suspension element allotropes of carbon battery cell outstanding one or two sides plate, sheet, foil, or leaf casted conductive highly pure metal, super alloy, halide, antimonide, or alkalide series and parallel circuits and two positive and negative terminal poles commonly copper alloy measured in Volts or two negative terminal poles commonly copper alloy measured in Ohms to antinode coupler or electronic parts requires one, or two, or more brushes in even intervals and two or more inductors and antinode couplers with one or two sides conductive plate, sheet, foil, or leaf casted highly pure metal, super alloy, halide, antimonide, or alkalide series and parallel circuits and two positive and negative terminal poles commonly copper alloy measured in Volts or two negative terminal poles commonly copper alloy measured in Ohms to antinode coupler. Number 16. An insulate, electronic part, brake calipers part, rotors part, brake pads, washers, spacers, shims, dowels, bushings part light weight chemical non ionic groups of amphoteric polysaccharide linear or branched alkyl compounds usually methyl continuous sheets cut films insulate, variable hydraulic press, plate or distillation reservoir liquid dispersion specifications of condensation-nuclei type size particles measure in microns Symbol μ lower-case letter mu metric SI equivalent silica, allotropes of carbon silica and alumina/nano alumina silica allotropes of carbon slurry non ionic heated or chilled interface 8—Slurry non ionic tool steel line in liquid dispersion heated or chilled chemical ionic acid usually an amino acid, non ionic bases usually nitrogen/hydrogen or non ionic groups of amphoteric polysaccharide linear or branched alkyl compounds usually methyl liquid dispersion heated chemical non ionic groups of amphoteric polysaccharide linear or branched alkyl compounds methyl liquid dispersion Silica, and allotropes of carbon alumina/nano alumina or liquid dispersion chilled polysaccharide linear or branched alkyl compounds and reinforcement of allotropes of carbon networks in suspension drying over usually fifteen minutes result network light weight Silica allotropes of carbon and/or alumina/nano alumina controllable, high purity, connectivity, strength, conductivity, and shape. Number 17. Battery crucible casted or 1.0 to 2.5 phase extrusions highly pure metal or super alloy battery cells layered, spaced and casted conductive in series and parallel circuits even or odd interval number combinations varying complex, battery cells highly pure acid solid chemical and/or highly pure chemical alkali solid complex, crucible casted conductive or 1.0 to 2.5 phase extrusions highly pure metal or super alloy layered and interval spaced conductive in series and parallel circuits. Distillation reservoir specification manufactured all conservation of energy law insulated lightweight battery cold cell with or without gaseous element suspension halogens, antimony, allotropes of carbon hydrogen carbon HC hydrocarbons compound, and highly pure ammonia with or without ionic suspension element allotropes of carbon, alternate carbon nanofoam inductor ACNFI, nanoparticle alumina, alumina, and ionic suspension element Specification 55 highly pure metals or ionic suspension element Specification 56 super alloys. Battery crucible casted conductive or 1.0 to 2.5 phase extrusions highly pure metal or super alloy layered, and interval spaced series and parallel circuits and/or complex, continuous sheets cut films insulate, crucible casted conductive or 1.0 to 2.5 phase extrusions variable hydraulic preform slurry non ionic silicate alumina allotropes of carbon dispersion high wear-heat compression resistant light weight battery cells. Highly pure alkali silica, alumina, nanoparticle alumina, or elements lithium, cadmium, nickel, lead, copper, Specification 55 elements or Specification 56 alloys. One by one each battery cell crucible casted non conductive or submersion bath synthetic polymer sealed control room vacuum protocol manufacture process. Motor frame protected by synthetic woven textile fiber, silica fiber high heat-resistant insulator shielding, continuous sheets cut films insulate, preform slurry non ionic silicate allotropes of carbon dispersion high wear-heat compression resistant light weight insulator, and/or or high tensile strength super alloy woven textile shielding. One by one each battery cell crucible casted or submersion bath synthetic polymer sealed control room vacuum protocol manufacture process. All four conductive or non conductive heat-wear high tensile strength and compression resistant insulators made in light makeweight monocombe design series 2π radians or one full turn and right angles corrugated compartmented techniques composite combinations thermoplastic sealed, layered or woven shielded. Number 18. Motor crucible casted or 1.0 to 2.5 phase extrusions highly pure metal or super alloy composite coils, composite windings, and alumina, copper, wire annealing, drawing, and spun coils, highly pure metal, super alloy drawing and annealing process for wire. Motor composite coils, composite windings commonly copper or super alloy include continuous or numeric interval mechanical advantage spools series and parallel conversion order shapes of rod, cylinder, sphere, rectangle, or square crucible casted or 1.0 to 2.5 phase extrusions. Motor electronic components brushes allotropes of carbon with or without ionic suspension elements each brush alternate carbon nanofoam inductors, and antinode coupler continuous or numeric alternating current AC electronic load supply ramps positive and negative terminal measured in Volts and monitors positive and negative terminal measured in Volts and negative and negative terminal poles commonly copper alloy measure in Ohms of inductor, antinode coupler, and ground series and parallel circuits. Spun numeric wrapped super alloy copper wire are synthetic polymer dipped or protected synthetic woven fibers, silica woven fibers, or high tensile strength super alloy allotropes of carbon shielding. Motor frame protected by synthetic woven textile fiber, silica fiber high heat-resistant insulator shielding, continuous sheets cut films insulate, preform slurry non ionic silicate allotropes of carbon dispersion high wear-heat compression resistant light weight insulator, and/or or high tensile strength super alloy woven textile shielding. One by one all composite or wire motor coils and windings are crucible casted or submersion bath synthetic polymer sealed control room vacuum protocol manufacture process. Three heat-wear high tensile strength, continuous sheets cut films insulate and variable hydraulic preform slurry non ionic silicate allotropes of carbon dispersion high wear-heat compression resistant light weight insulators made Series of right angles 2π radians or one full turn the sum of the exterior angles form convex regular polygons corrugated and compartmented architecture techniques monocombe shapes of triangle square pentagon hexagon heptagon octagon and nonagon and right angle combinations light makeweight design. Crucible casted or 1.0 to 2.5 phase extrusions motor rods, bearings, casings, housings, and assemblies are manufactured and assembled.

4. One and two or more star systems order of the universe or well-lit source radiate light onto parallel 1—optical glass lens and 2—lightweight universal spectra camera and monitor panel shell numeric horizontal and vertical sectors receiving light of added and subtracted magnification and telescopic lenses travelling to scientific mirrors reflecting light onto ˜1.25-inch analogous scanning photo chemical electron molecule film and 2—numeric horizontal and vertical sectors ˜10 inch lightweight universal spectra camera and monitor linearized panel shell integrated or polarized alignment numeric optical lenses, glass beads, and polymer gels form scientific optical light reception and identification receiving emissions of light added and subtracted magnification and telescopic lenses transposed onto analogous scanning photo chemical electron molecule enriched conductive allotropes of carbon, alumina nanoparticles, copper nanoparticles, colloidal gold, silver nanoparticles, iron nanoparticles, element nanoparticles and platinum nanoparticles series and parallel circuit film element and complex element acid, base, alkyl, ionic and non ionic film enriched conductive acid, base, alkyl, ionic, non ionic, element and enriched complex element cells occupying vertical and horizontal segments equal to photo graphic picture resolution. Two sided panel shell thermoelectrically sealed vertical and horizontal sectors in series and parallel circuits highly pure metal alumina atomic symbol Al number 13 annealing, drawing, and spun fine wire or press rolled flat strips fine wire and shielding analogous scanning photo chemical electron molecule enriched conductive emissions allotropes of carbon, alumina nanoparticles, copper nanoparticles, colloidal gold, silver nanoparticles, iron nanoparticles, element nanoparticles and platinum nanoparticles series circuit waveform generation symbol light of CMY cyan, magenta, yellow, RGB red, green, blue, and analogous scanning photo chemical electron molecule enriched conductive emissions allotropes of carbon, alumina nanoparticles, copper nanoparticles, colloidal gold, silver nanoparticles, iron nanoparticles, element nanoparticles and platinum nanoparticles series circuit waveform generation symbol light of alternate carbon nanofoam inductor ACNFI atomic number 6 symbol C pure light, filtered light, colored light and reflective light wavelength frequency received in nanoseconds processing by central processing unit CPU wavelength shift generator frequency counter and frequency analyzer order of central processing unit CPU wavelength shift generator added and subtracted changes order of wavenumber data output nanoseconds processor spectra wavelength frequency pure light, filtered light, colored light, and reflective light electronic data random access memory RAM and writable random access memory WRAM compact disc. The universal spectra camera and monitor glass bead molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications cables light emissions wavelength frequency light filtered light identification and photo active chemical electron molecule element scanning analogous series and parallel alumina atomic symbol Al and number 13 wire and shielding +/−wavelength shift generator medium random access memory RAM and writable random access memory WRAM compact disc data streams series viewing of the universal spectra camera and monitor panel shell thermoelectrically sealed sectors numeric 1—highly pure mineral or complex element electrolyte Liquid crystal mineralization methane light emitting diode LED and 2—symbol generator light optical reflective beads reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, Liquid crystal mineralization methane light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, and Liquid crystal mineralization light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors series and parallel highly pure metal alumina atomic symbol Al number 13 annealing, drawing, and spun fine wire or press rolled flat strips fine wire and shielding equal to vertical and horizontal picture resolution. Chlorophyll A ionic or anionic 2—parts 1+positive and 1−negative enriched chemical electron molecules and B ionic or anionic 2—parts 1+positive and 1−negative enriched chemical electron molecules photo active chemical electron molecule element film cells in series and parallel circuits Chlorophyll A ionic or anionic 2—parts 1+positive and 1−negative enriched chemical electron molecules and B ionic or anionic 2—parts 1+positive and 1 −negative enriched chemical electron molecules photo active chemical electron molecule element film cells emissions in wavelength frequency counter and analyzer order of photo emissions light filtered light identification scanning analogous photo active chemical electron molecule element film cells circuits data output +/−wavelength shift generator. The CMY cyan, magenta, yellow, RGB red, green, blue, and alternate carbon nanofoam inductor ACNFI atomic number 6 symbol C pure light, filtered light, colored light and reflective light wavelength frequency received in nanoseconds processing by central processing unit CPU wavelength shift generator frequency counter and frequency analyzer order of central processing unit CPU wavelength shift generator added and subtracted changes of the order of wavenumber data output nanoseconds processor spectra wavelength frequency pure light, filtered light, colored light, and reflective light data streams series viewing sectors numeric 1—highly pure mineral or complex element electrolyte Liquid crystal mineralization methane light emitting diode LED and 2—symbol generator light optical reflective beads reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, Liquid crystal mineralization methane light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, and Liquid crystal mineralization light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors series and parallel highly pure metal alumina atomic symbol Al number 13 annealing, drawing, and spun fine wire or press rolled flat strips fine wire and shielding equal to the vertical and horizontal picture resolution. Two sided panel shell consists numeric sums of reflected delineations occupying vertical and horizontal segments equal to photo graphic picture resolution of integrated or polarized greater than high temperatures ˜1700° C. and 2200° C. crystalline silica optical reflective glass beads spectra light filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Similarly greater than high temperatures ˜1700° C. and 2200° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Liquid dispersion supersaturated liquids of condensation-nuclei matters two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective beads emissions of light spectra wavelength frequency onto optical reflective cables process in nanoseconds spectra wavelength frequency to central processing unit CPU wavelength shift and light symbol generator frequency counter and frequency analyzer order of wavelength frequency added and subtracted changes order of wavenumber data output in nanoseconds processing spectra wavelength frequency and light symbol generation pure light, filtered light, colored light, and reflective light and electronic data output random accessible memory RAM and writable random accessible memory WRAM compact disc. Two sided panel shell consists numeric sums of reflected centers occupying vertical and horizontal segments equal to photo graphic picture resolution of integrated or polarized greater than high temperatures ˜1700° C. and 2200° C. crystalline silica optical reflective glass beads spectra light filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Similarly greater than high temperatures ˜1700° C. and 2200° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Liquid dispersion supersaturated liquids of condensation-nuclei matters two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective beads emissions of light spectra wavelength frequency onto optical reflective cables process in nanoseconds spectra wavelength frequency to central processing unit CPU wavelength shift and light symbol generator frequency counter and frequency analyzer order of wavelength frequency added and subtracted changes order of wavenumber data output in nanoseconds processing spectra wavelength frequency and light symbol generation pure light, filtered light, colored light, and reflective light and electronic data output random accessible memory RAM and writable random accessible memory WRAM compact disc. Two sided panel shell consists numeric sums of reflective centers of integrated or polarized greater than high temperatures ˜1700° C. and 2200° C. crystalline silica optical reflective glass beads spectra light filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Similarly greater than high temperatures ˜1700° C. and 2200° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications, lower and greater than low temperatures ˜178° C. molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications. Liquid dispersion supersaturated liquids of condensation-nuclei matters two or more composites 0° C. or 32° F. of optical beads and optical cable line manufacturing are light makeweight heated or chilled chemical ionic acid usually an amino acid, non ionic bases usually nitrogen/hydrogen or non ionic groups of amphoteric polysaccharide linear or branched alkyl compounds usually methyl liquid dispersion optical grade Silica spectra light filtered and non filtered specifications, optical grade polyamide silica spectra light filtered and non filtered specifications, continuous forged liquid dispersion optical grade silica line cable spectra light filtered and non filtered specifications, continuous forged liquid dispersion optical grade polyamide silica line cable spectra light filtered and non filtered specifications equivalent condensation-nuclei type size particles measure in microns Symbol μ lower-case letter mu metric SI. Integrated or polarized alignment circuit optical reflective cables emissions of light spectra wavelength frequency symbol generator light onto optical reflective beads processed in nanoseconds spectra wavelength frequency from central processing unit CPU wavelength shift and light symbol generator frequency counter and frequency analyzer order of wavelength frequency added and subtracted changes order of wavenumber data output in nanoseconds processing spectra wavelength frequency and light symbol generation pure light, filtered light, colored light, and reflective light emissions output. The KIOSK universal spectra camera and monitor panel shell thermoelectrically sealed vertical and horizontal sectors numeric 1—highly pure mineral or complex element electrolyte Liquid crystal mineralization methane light emitting diode LED and 2—symbol generator light optical reflective beads reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, Liquid crystal mineralization methane light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead, and Liquid crystal mineralization light emitting diode LED reflective magnification molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels glass bead alumina Al13 strips occupying vertical and horizontal segments of photo graphic picture resolution light emitting diode LED cells in CMY cyan, magenta, yellow, RGB red, green, blue, filtered light and specification colors integrated or polarized alignment optical high purity panel, molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels molten diffusion particulate matter PM melts crystalline silica optical, crystalline silica synthetic polymer optical, crystalline silica cellulosic natural polymer, and crystalline silica cellulosic rubber natural polymer optical filtered and non filtered specifications beads, gels, cables, lenses, mirrors, visors and panels gels finished touch screen kiosk in series circuits highly pure metal alumina atomic symbol Al number 13 annealing, drawing, and spun fine wire or press rolled flat strips fine wire and shielding receiving negative electron molecules wavelength frequency alternate carbon nanofoam inductor ACNFI touch screen kiosk sensory cells panel shell thermoelectrically sealed vertical and horizontal sectors series circuits highly pure metal alumina atomic symbol Al number 13 annealing, drawing, and spun fine wire or press rolled flat strips fine wire and shielding process in nanoseconds negative electron molecules wavelength frequency to central processing unit CPU wavelength generator added and subtracted changes of the order of wavenumber data output nanoseconds processor negative electron molecules wavelength frequency. Keyboard computing device typewriter-style arrangement of keys supplied by a central processing unit CPU processor made up of a manual mechanical arrangement of keys in series and parallel circuits occupying a horizontal plane with various ports, and plug-ins connectivity. Keyboard key parts in series and parallel analogous circuits of enriched highly pure metal molecular copper atomic symbol Cu and number 29, and alumina atomic symbol Al number 13 annealing, drawing, and spun fine wire or press rolled flat strips fine wire and shielding receiving negative electron molecules wavelength frequency keys from keyboard process in nanoseconds electron molecules wavelength frequency keys to central processing unit CPU processor wavelength generator added and subtracted changes of the order of wavenumber data output nanoseconds processing electron molecules wavelength frequency keys identification and series medium random access memory RAM and writable random access memory WRAM compact disc data streams +/−connectivity. The keys consist of and not limited Arabic number keys 0, 1, 2, 3, 4, 5, 6, 7, 8, and 9, various symbol keys transposed on top of number keys !, @, #, $, %, ̂, &, *, (, and ), various symbol keys occupy their own keys and keys transposed on top of various symbol keys -, =, [, ], \, ;, ', ,, ., /, ′, _, +, {, }, |, :, ″, <, >, ?, and ˜, The International Organization for Standardization ISO basic Latin-script alphabet consists of the following 26 letters alphabet keys in upper-case Q, W, E, R, T, Y, U, I, O, P, A, S, D, F, G, H, J, K, L, Z, X, C, V, B, N, and M, alphabet key in lower-case q, w, e, r, t, y, u, I, o, p, a, s, d, f, g, h, j, k, l, z, x, c, v, b, n, and m, function specific keys space bar, enter, escape, shift, tab, alternate, escape, control, number lock, caps lock, backspace, right arrow, left arrow, up arrow, down arrow, all direction arrow, page-up, page-down, control, function, consecutive Function F1 to F12, home, end, pause, insert, and delete. The pure light, filtered light, colored light, and reflective light data output spectra wavelength frequency is received by central processing unit CPU wavelength shift generator printer of pure light, filtered light, colored light, and reflective light supersaturated particulate matter colored and shaded scale pigments natural polymer-carbonaceous inks, toner powders and printed films.
